(19) United States
(12) Patent Application Publication
(10) Pub. No.: US 2025/0374232 A1
(43) Pub. Date: Dec. 4, 2025

(54) COMMUNICATION METHOD AND COMMUNICATION APPARATUS

(71) Applicant: HUAWEI TECHNOLOGIES CO., LTD., Shenzhen (CN)

(72) Inventors: Jingwei Zhang, Hangzhou (CN); Ying Chen, Hangzhou (CN); Yunfei Qiao, Hangzhou (CN); Xiaolei Tie, Shanghai (CN); Yinggang Du, Shenzhen (CN)

(73) Assignee: HUAWEI TECHNOLOGIES CO., LTD., Shenzhen (CN)

(21) Appl. No.: 19/301,055

(22) Filed: Aug. 15, 2025

Related U.S. Application Data
(63) Continuation of application No. PCT/CN2024/077097, filed on Feb. 9, 2024.

(30) Foreign Application Priority Data
Feb. 17, 2023 (CN) 202310176180.8

(51) Int. Cl. H04W 64/00

(52) U.S. Cl. CPC H04W 64/00

(57) ABSTRACT

A method includes: receiving a first downlink frame from a second communication apparatus; sending a first uplink frame to the second communication apparatus; and sending first information to a positioning server, where the first information indicates a first time difference between receiving time for receiving an i^{th} first downlink subframe in the first downlink frame and sending time for sending a k^{th} first uplink subframe in the first uplink frame. The first information is sent to the positioning server, so that location management can verify a location of a first communication apparatus based on the time difference between the receiving time at which the first communication apparatus receives the i^{th} first downlink subframe and the sending time at which the first communication apparatus sends the k^{th} first uplink subframe.

### CROSS-REFERENCE TO RELATED APPLICATIONS

This application is a continuation of International Application No. PCT/CN2024/077097, filed on Feb. 9, 2024, which claims priority to Chinese Patent Application No. 202310176180.8, filed on Feb. 17, 2023. The disclosures of the aforementioned applications are hereby incorporated by reference in their entireties.

### TECHNICAL FIELD

This application relates to the field of communication technologies, and in particular, to a communication method and a communication apparatus.

### BACKGROUND

Compared with a conventional mobile communication system, satellite communication has a wider coverage and supports an asymmetric transmission link. Communication costs are irrelevant to a transmission distance. Satellite communication can overcome natural geographical obstacles such as oceans, deserts, and mountains. In satellite communication, a satellite cell usually covers a large area, and may cross a border to cover a plurality of countries and regions. When providing communication services such as disaster warning, an emergency call, and charging in compliance with laws and regulations of each country or region, a satellite usually needs to know a location of a terminal device.

In existing satellite communication, positioning of a ground terminal device is usually implemented by using a dedicated positioning satellite, and the positioning satellite is mainly used by the terminal device to position the terminal device itself. The terminal device reports location information of the terminal device to a network side. However, the location information reported by the ground terminal device may be tampered with, or a large error may exist in the reported location information due to interference. Therefore, how to implement positioning of the ground terminal device by the network side or verification of the location information reported by the ground terminal device is a problem that needs to be resolved.

### SUMMARY

This application provides a communication method and a communication apparatus, to implement positioning and location verification of a terminal device in a satellite communication scenario.

According to a first aspect, a communication method is provided. The method may be performed by a first communication apparatus. The first communication apparatus may be a terminal device, or may be a chip or a circuit configured in a terminal device. This is not limited in this application. The following uses an example in which the method is performed by the first communication apparatus for description.

The method includes: receiving a first downlink frame from a second communication apparatus; sending a first uplink frame to the second communication apparatus; and sending first information to a positioning server, where the first information indicates a first time difference between receiving time for receiving an i^{th} first downlink subframe in the first downlink frame and sending time for sending a k^{th} first uplink subframe in the first uplink frame.

Based on the foregoing technical solution, the first information is sent to the positioning server, so that location management can verify a location of the first communication apparatus based on the time difference between the receiving time at which the first communication apparatus receives the i^{th} first downlink subframe and the sending time at which the first communication apparatus sends the k^{th} first uplink subframe.

In some embodiments, the first information includes the first time difference, and the first time difference includes a sum of a third time difference and a fourth time difference; or the first information includes a third time difference and a fourth time difference; and the third time difference is a time difference between the receiving time for the i^{th} first downlink subframe and sending time for sending a second uplink subframe, the sending time for the second uplink subframe is closest to the receiving time for the i^{th} first downlink subframe, and the fourth time difference is a time difference between the sending time for the second uplink subframe and the sending time for the k^{th} first uplink subframe.

In some embodiments, an uplink frame in which the second uplink subframe is located is different from the first uplink frame.

In some embodiments, the first information includes the first time difference, and the first time difference includes a sum of a fifth time difference and a sixth time difference; or the first information includes a fifth time difference and a sixth time difference; and the fifth time difference is a time difference between the sending time for the k^{th} first uplink subframe and receiving time for receiving a second downlink subframe, the receiving time for the second downlink subframe is closest to the sending time for the k^{th} first uplink subframe, and the sixth time difference is a time difference between the receiving time for the i^{th} first downlink subframe and the receiving time for the second downlink subframe.

In some embodiments, the first information includes the first time difference, and the first time difference includes a sum of a third time difference, a fifth time difference, and a seventh time difference; or the first information includes a third time difference, a fifth time difference, and a seventh time difference; and the third time difference is a time difference between the receiving time for the i^{th} first downlink subframe and sending time for sending a second uplink subframe, the sending time for the second uplink subframe is closest to the receiving time for the i^{th} first downlink subframe, the fifth time difference is a time difference between the sending time for the k^{th} first uplink subframe and receiving time for receiving a second downlink subframe, the receiving time for the second downlink subframe is closest to the sending time for the k^{th} first uplink subframe, and the seventh time difference is a time difference between the receiving time for the second downlink subframe and the sending time for the second uplink subframe.

In some embodiments, the method includes: sending first indication information to the second communication apparatus, where the first indication information indicates a subframe number of the second uplink subframe; or the second uplink subframe carries a reference signal.

In some embodiments, the method includes: sending second indication information to the second communication apparatus, where the second indication information indicates that an uplink subframe closest to the receiving time for the i^{th} first downlink subframe is the k^{th} first uplink subframe, or indicates that an uplink subframe closest to the receiving time for the i^{th} first downlink subframe is a (k−1)^{th} first uplink subframe.

In some embodiments, the second indication information is 1-bit information, and a value of the 1 bit is 0 or 1; and when a value of the 1-bit information is 0, the second indication information indicates that the uplink subframe closest to the receiving time for the i^{th} first downlink subframe is the k^{th} first uplink subframe, and when a value of the 1-bit information is 1, the second indication information indicates that the uplink subframe closest to the receiving time for the i^{th} first downlink subframe is the (k−1)^{th} first uplink subframe; or when a value of the 1-bit information is 0, the second indication information indicates that the uplink subframe closest to the receiving time for the i^{th} first downlink subframe is the (k−1)^{th} first uplink subframe, and when a value of the 1-bit information is 1, the second indication information indicates that the uplink subframe closest to the receiving time for the i^{th} first downlink subframe is the k^{th} first uplink subframe.

In some embodiments, before sending the second indication information to the second communication apparatus, the method further includes: receiving third indication information from the second communication apparatus, where the third indication information indicates a subframe number of a subframe required for sending, and the required subframe is an uplink subframe j closest to the receiving time for the i^{th} first downlink subframe.

In some embodiments, the first information includes the first time difference, and the first time difference is a time difference between a first moment and a second moment; or the first information includes a first moment and a second moment; and the first moment is a moment for receiving the i^{th} first downlink subframe, and the second moment is a sending moment for sending the k^{th} first uplink subframe.

In some embodiments, the method further includes: sending a second uplink frame to the second communication apparatus; and receiving a second downlink frame from the second communication apparatus, where the second uplink frame is used to determine second information, and the second information indicates a second time difference between receiving time for receiving an x^{th} third uplink subframe in the second uplink frame and sending time for sending a y^{th} third downlink subframe in the second downlink frame.

In some embodiments, the second information includes the second time difference, and the second time difference includes a sum of an eighth time difference and a ninth time difference; or the second information includes an eighth time difference and a ninth time difference; and the eighth time difference is a time difference between the receiving time for the x^{th} third uplink subframe and sending time for sending a fourth downlink subframe, the sending time for the fourth downlink subframe is closest to the receiving time for the x^{th} third uplink subframe, and the ninth time difference is a time difference between the sending time for the fourth downlink subframe and the sending time for the y^{th} third downlink subframe.

In some embodiments, the second information includes the second time difference, and the second time difference includes a sum of a tenth time difference and an eleventh time difference; or the second information includes a tenth time difference and an eleventh time difference; and the tenth time difference is a time difference between the sending time for the y^{th} third downlink subframe and receiving time for receiving a fourth uplink subframe, the receiving time for the fourth uplink subframe is closest to the sending time for the y^{th} third downlink subframe, and the eleventh time difference is a time difference between the receiving time for the fourth uplink subframe and the receiving time for the x^{th} third uplink subframe.

In some embodiments, the second information includes the second time difference, and the second time difference includes a sum of an eighth time difference, a tenth time difference, and a twelfth time difference; or the second information includes an eighth time difference, a tenth time difference, and a twelfth time difference; and the eighth time difference is a time difference between the receiving time for the x^{th} third uplink subframe and sending time for sending a fourth downlink subframe, the sending time for the fourth downlink subframe is closest to the receiving time for the x^{th} third uplink subframe, the tenth time difference is a time difference between the sending time for the y^{th} third downlink subframe and receiving time for receiving a fourth uplink subframe, the receiving time for the fourth uplink subframe is closest to the sending time for the y^{th} third downlink subframe, and the twelfth time difference is a time difference between the receiving time for the fourth uplink subframe and the sending time for sending the fourth downlink subframe.

In some embodiments, the method further includes: receiving fourth indication information from the second communication apparatus, where the fourth indication information indicates a subframe number of the fourth downlink subframe; or the fourth downlink subframe carries a reference signal.

In some embodiments, the second information includes the second time difference, and the second time difference is a time difference between a third moment and a fourth moment; or the first information includes a third moment and a fourth moment; and the third moment is a moment for receiving the x^{th} third uplink subframe, and the fourth moment is a moment for sending the y^{th} third downlink subframe.

In some embodiments, the method further includes: receiving first configuration information from a location management network element, where the first configuration information indicates to determine the first information.

According to a second aspect, a communication method is provided. The method may be performed by a second communication apparatus. The second communication apparatus may be a network device, or may be a chip or a circuit configured in a network device. This is not limited in this application. The following uses an example in which the method is performed by the second communication apparatus for description.

The method includes: sending a first downlink frame to a first communication apparatus; receiving a first uplink frame from the first communication apparatus; receiving first information from the first communication apparatus, where the first information indicates a first time difference between receiving time for receiving an i^{th} first downlink subframe in the first downlink frame and sending time for sending a k^{th} first uplink subframe in the first uplink frame; and sending the first information to a positioning server, where the first information is used by the positioning server to verify a location of a terminal device.

Based on the foregoing technical solution, the first information of the first communication apparatus is sent to the positioning server, so that location management can verify a location of the first communication apparatus based on the time difference between the receiving time at which the first communication apparatus receives the i^{th} first downlink subframe and the sending time at which the first communication apparatus sends the k^{th} first uplink subframe.

In some embodiments, the first information includes the first time difference, and the first time difference includes a sum of a third time difference and a fourth time difference; or the first information includes a third time difference and a fourth time difference; and the third time difference is a time difference between the receiving time for the i^{th} first downlink subframe and sending time for sending a second uplink subframe, the sending time for the second uplink subframe is closest to the receiving time for the i^{th} first downlink subframe, and the fourth time difference is a time difference between the sending time for the second uplink subframe and the sending time for the k^{th} first uplink subframe.

In some embodiments, an uplink frame in which the second uplink subframe is located is different from the first uplink frame.

In some embodiments, the first information includes the first time difference, and the first time difference includes a sum of a fifth time difference and a sixth time difference; or the first information includes a fifth time difference and a sixth time difference; and the fifth time difference is a time difference between the sending time for the k^{th} first uplink subframe and receiving time for receiving a second downlink subframe, the receiving time for the second downlink subframe is closest to the sending time for the k^{th} first uplink subframe, and the sixth time difference is a time difference between the receiving time for the i^{th} first downlink subframe and the receiving time for the second downlink subframe.

In some embodiments, the first information includes the first time difference, and the first time difference includes a sum of a third time difference, a fifth time difference, and a seventh time difference; or the first information includes a third time difference, a fifth time difference, and a seventh time difference; and the third time difference is a time difference between the receiving time for the i^{th} first downlink subframe and sending time for sending a second uplink subframe, the sending time for the second uplink subframe is closest to the receiving time for the i^{th} first downlink subframe, the fifth time difference is a time difference between the sending time for the k^{th} first uplink subframe and receiving time for receiving a second downlink subframe, the receiving time for the second downlink subframe is closest to the sending time for the k^{th} first uplink subframe, and the seventh time difference is a time difference between the receiving time for the second downlink subframe and the sending time for the second uplink subframe.

In some embodiments, the method further includes: receiving first indication information from the first communication apparatus, where the first indication information indicates a subframe number of the second uplink subframe; or the second uplink subframe carries a reference signal.

In some embodiments, the method includes: receiving second indication information from the first communication apparatus, where the second indication information indicates that an uplink subframe closest to the receiving time for the i^{th} first downlink subframe is the k^{th} first uplink subframe, or indicates that an uplink subframe closest to the receiving time for the i^{th} first downlink subframe is a (k−1)^{th} first uplink subframe.

In some embodiments, the second indication information is 1-bit information, and a value of the 1 bit is 0 or 1; and
when a value of the 1-bit information is 0, the second indication information indicates that the uplink subframe closest to the receiving time for the i^{th} first downlink subframe is the k^{th} first uplink subframe, and when a value of the 1-bit information is 1, the second indication information indicates that the uplink subframe closest to the receiving time for the i^{th} first downlink subframe is the (k−1)^{th} first uplink subframe; or
when a value of the 1-bit information is 0, the second indication information indicates that the uplink subframe closest to the receiving time for the i^{th} first downlink subframe is the (k−1)^{th} first uplink subframe, and when a value of the 1-bit information is 1, the second indication information indicates that the uplink subframe closest to the receiving time for the i^{th} first downlink subframe is the k^{th} first uplink subframe.

With reference to the second aspect, in some implementations of the second aspect, before receiving the second indication information from the first communication apparatus, the method further includes: sending third indication information to the first communication apparatus, where the third indication information indicates a subframe number of a subframe required for sending, and the required subframe is an uplink subframe j closest to the receiving time for the i^{th} first downlink subframe.

In some embodiments, the first information includes the first time difference, and the first time difference is a time difference between a first moment and a second moment; or the first information includes a first moment and a second moment; and the first moment is a moment for receiving the i^{th} first downlink subframe, and the second moment is a sending moment for sending the k^{th} first uplink subframe.

In some embodiments, the method further includes: receiving a second uplink frame from the first communication apparatus; sending a second downlink frame to the first communication apparatus; and sending second information to the positioning server, where the second information indicates a second time difference between receiving time for receiving an x^{th} third uplink subframe in the second uplink frame and sending time for sending a y^{th} third downlink subframe in the second downlink frame.

In some embodiments, the second information includes the second time difference, and the second time difference includes a sum of an eighth time difference and a ninth time difference; or the second information includes an eighth time difference and a ninth time difference; and the eighth time difference is a time difference between the receiving time for the x^{th} third uplink subframe and sending time for sending a fourth downlink subframe, the sending time for the fourth downlink subframe is closest to the receiving time for the x^{th} third uplink subframe, and the ninth time difference is a time difference between the sending time for the fourth downlink subframe and the sending time for the y^{th} third downlink subframe.

In some embodiments, the second information includes the second time difference, and the second time difference includes a sum of a tenth time difference and an eleventh time difference; or the second information includes a tenth time difference and an eleventh time difference; and the tenth time difference is a time difference between the sending time for the y^{th} third downlink subframe and receiving time for receiving a fourth uplink subframe, the receiving time for the fourth uplink subframe is closest to the sending time for the y^{th} third downlink subframe, and the eleventh time difference is a time difference between the receiving time for the fourth uplink subframe and the receiving time for the x^{th} third uplink subframe.

In some embodiments, the second information includes the second time difference, and the second time difference includes a sum of an eighth time difference, a tenth time difference, and a twelfth time difference; or the second information includes an eighth time difference, a tenth time difference, and a twelfth time difference; and the eighth time difference is a time difference between the receiving time for the x^{th} third uplink subframe and sending time for sending a fourth downlink subframe, the sending time for the fourth downlink subframe is closest to the receiving time for the x^{th} third uplink subframe, the tenth time difference is a time difference between the sending time for the y^{th} third downlink subframe and receiving time for receiving a fourth uplink subframe, the receiving time for the fourth uplink subframe is closest to the sending time for the y^{th} third downlink subframe, and the twelfth time difference is a time difference between the receiving time for the fourth uplink subframe and the sending time for sending the fourth downlink subframe.

In some embodiments, the method further includes: sending fourth indication information to the first communication apparatus, where the fourth indication information indicates a subframe number of the fourth downlink subframe; or the fourth downlink subframe carries a reference signal.

In some embodiments, the second information includes the second time difference, and the second time difference is a time difference between a third moment and a fourth moment; or the first information includes a third moment and a fourth moment; and the third moment is a moment for receiving the x^{th} third uplink subframe, and the fourth moment is a moment for sending the y^{th} third downlink subframe.

In some embodiments, the method further includes: receiving first configuration information from the positioning server, where the first configuration information indicates to determine the first information; and sending the first configuration information to the first communication apparatus.

In some embodiments, the method further includes: receiving second configuration information from the positioning server, where the second configuration information indicates to determine the second information.

According to a third aspect, a communication method is provided. The method may be performed by a positioning server, and the method may be performed by the positioning server.

The method includes: receiving first information from a second communication apparatus, where the first information indicates a first time difference between receiving time at which a first communication apparatus receives an i^{th} first downlink subframe in a first downlink frame and sending time at which the first communication apparatus sends a k^{th} first uplink subframe in a first uplink frame; and verifying a location of a terminal device based on the first information.

Based on the foregoing technical solution, the positioning server receives the first information from the first communication apparatus, so that the positioning server can verify a location of the first communication apparatus based on the time difference between the receiving time at which the first communication apparatus receives the i^{th} first downlink subframe and the sending time at which the first communication apparatus sends the k^{th} first uplink subframe.

In some embodiments, the first information includes the first time difference, and the first time difference includes a sum of a third time difference and a fourth time difference; or the first information includes a third time difference and a fourth time difference; and the third time difference is a time difference between the receiving time for the i^{th} first downlink subframe and sending time for sending a second uplink subframe, the sending time for the second uplink subframe is closest to the receiving time for the i^{th} first downlink subframe, and the fourth time difference is a time difference between the sending time for the second uplink subframe and the sending time for the k^{th} first uplink subframe.

In some embodiments, an uplink frame in which the second uplink subframe is located is different from the first uplink frame.

In some embodiments, the first information includes the first time difference, and the first time difference includes a sum of a fifth time difference and a sixth time difference; or the first information includes a fifth time difference and a sixth time difference; and the fifth time difference is a time difference between the sending time for the k^{th} first uplink subframe and receiving time for receiving a second downlink subframe, the receiving time for the second downlink subframe is closest to the sending time for the k^{th} first uplink subframe, and the sixth time difference is a time difference between the receiving time for the i^{th} first downlink subframe and the receiving time for the second downlink subframe.

In some embodiments, the first information includes the first time difference, and the first time difference includes a sum of a third time difference, a fifth time difference, and a seventh time difference; or the first information includes a third time difference, a fifth time difference, and a seventh time difference; and the third time difference is a time difference between the receiving time for the i^{th} first downlink subframe and sending time for sending a second uplink subframe, the sending time for the second uplink subframe is closest to the receiving time for the i^{th} first downlink subframe, the fifth time difference is a time difference between the sending time for the k^{th} first uplink subframe and receiving time for receiving a second downlink subframe, the receiving time for the second downlink subframe is closest to the sending time for the k^{th} first uplink subframe, and the seventh time difference is a time difference between the receiving time for the second downlink subframe and the sending time for the second uplink subframe.

In some embodiments, the first information includes the first time difference, and the first time difference is a time difference between a first moment and a second moment; or the first information includes a first moment and a second moment; and the first moment is a moment for receiving the i^{th} first downlink subframe, and the second moment is a sending moment for sending the k^{th} first uplink subframe.

In some embodiments, the method further includes: receiving second information from the second communication apparatus, where the second information indicates a second time difference between receiving time at which the second communication apparatus receives an x^{th} third uplink subframe in a second uplink frame and sending time at which the second communication apparatus sends a y^{th} third downlink subframe in a second downlink frame.

In some embodiments, the second information includes the second time difference, and the second time difference includes a sum of an eighth time difference and a ninth time difference; or the second information includes an eighth time difference and a ninth time difference; and the eighth time difference is a time difference between the receiving time for the x^{th} third uplink subframe and sending time for sending a fourth downlink subframe, the sending time for the fourth downlink subframe is closest to the receiving time for the x^{th} third uplink subframe, and the ninth time difference is a time difference between the sending time for the fourth downlink subframe and the sending time for the y^{th} third downlink subframe.

In some embodiments, the second information includes the second time difference, and the second time difference includes a sum of a tenth time difference and an eleventh time difference; or the second information includes a tenth time difference and an eleventh time difference; and the tenth time difference is a time difference between the sending time for the y^{th} third downlink subframe and receiving time for receiving a fourth uplink subframe, the receiving time for the fourth uplink subframe is closest to the sending time for the y^{th} third downlink subframe, and the eleventh time difference is a time difference between the receiving time for the fourth uplink subframe and the receiving time for the x^{th} third uplink subframe.

In some embodiments, the second information includes the second time difference, and the second time difference includes a sum of an eighth time difference, a tenth time difference, and a twelfth time difference; or the second information includes an eighth time difference, a tenth time difference, and a twelfth time difference; and the eighth time difference is a time difference between the receiving time for the x^{th} third uplink subframe and sending time for sending a fourth downlink subframe, the sending time for the fourth downlink subframe is closest to the receiving time for the x^{th} third uplink subframe, the tenth time difference is a time difference between the sending time for the y^{th} third downlink subframe and receiving time for receiving a fourth uplink subframe, the receiving time for the fourth uplink subframe is closest to the sending time for the y^{th} third downlink subframe, and the twelfth time difference is a time difference between the receiving time for the fourth uplink subframe and the sending time for sending the fourth downlink subframe.

In some embodiments, the second information includes the second time difference, and the second time difference is a time difference between a third moment and a fourth moment; or the first information includes a third moment and a fourth moment; and the third moment is a moment for receiving the x^{th} third uplink subframe, and the fourth moment is a moment for sending the y^{th} third downlink subframe.

In some embodiments, the method further includes: sending first configuration information and second configuration information to the second communication apparatus, where the first configuration information indicates to determine the first information, and the second configuration information indicates to determine the second information.

According to a fourth aspect, a communication apparatus is provided, where the apparatus includes a transceiver unit, and the transceiver unit is configured to: receive a first downlink frame from a second communication apparatus; send a first uplink frame to the second communication apparatus; and send first information to a positioning server, where the first information indicates a first time difference between receiving time for receiving an i^{th} first downlink subframe in the first downlink frame and sending time for sending a k^{th} first uplink subframe in the first uplink frame.

In some embodiments, the first information includes the first time difference, and the first time difference includes a sum of a third time difference and a fourth time difference; or the first information includes a third time difference and a fourth time difference; and the third time difference is a time difference between the receiving time for the i^{th} first downlink subframe and sending time for sending a second uplink subframe, the sending time for the second uplink subframe is closest to the receiving time for the i^{th} first downlink subframe, and the fourth time difference is a time difference between the sending time for the second uplink subframe and the sending time for the k^{th} first uplink subframe.

In some embodiments, an uplink frame in which the second uplink subframe is located is different from the first uplink frame.

In some embodiments, the first information includes the first time difference, and the first time difference includes a sum of a fifth time difference and a sixth time difference; or the first information includes a fifth time difference and a sixth time difference; and the fifth time difference is a time difference between the sending time for the k^{th} first uplink subframe and receiving time for receiving a second downlink subframe, the receiving time for the second downlink subframe is closest to the sending time for the k^{th} first uplink subframe, and the sixth time difference is a time difference between the receiving time for the i^{th} first downlink subframe and the receiving time for the second downlink subframe.

In some embodiments, the first information includes the first time difference, and the first time difference includes a sum of a third time difference, a fifth time difference, and a seventh time difference; or the first information includes a third time difference, a fifth time difference, and a seventh time difference; and the third time difference is a time difference between the receiving time for the i^{th} first downlink subframe and sending time for sending a second uplink subframe, the sending time for the second uplink subframe is closest to the receiving time for the i^{th} first downlink subframe, the fifth time difference is a time difference between the sending time for the k^{th} first uplink subframe and receiving time for receiving a second downlink subframe, the receiving time for the second downlink subframe is closest to the sending time for the k^{th} first uplink subframe, and the seventh time difference is a time difference between the receiving time for the second downlink subframe and the sending time for the second uplink subframe.

In some embodiments, the transceiver unit is further configured to send first indication information to the second communication apparatus, where the first indication information indicates a subframe number of the second uplink subframe; or the second uplink subframe carries a reference signal.

In some embodiments, the transceiver unit is further configured to send second indication information to the second communication apparatus, where the second indication information indicates that an uplink subframe closest to the receiving time for the i^{th} first downlink subframe is the k^{th} first uplink subframe, or indicates that an uplink subframe closest to the receiving time for the i^{th} first downlink subframe is a (k−1)^{th} first uplink subframe.

In some embodiments, the second indication information is 1-bit information, and a value of the 1 bit is 0 or 1; and when a value of the 1-bit information is 0, the second indication information indicates that the uplink subframe closest to the receiving time for the i^{th} first downlink subframe is the k^{th} first uplink subframe, and when a value of the 1-bit information is 1, the second indication information indicates that the uplink subframe closest to the receiving time for the i^{th} first downlink subframe is the (k−1)^{th} first uplink subframe; or when a value of the 1-bit information is 0, the second indication information indicates that the uplink subframe closest to the receiving time for the i^{th} first downlink subframe is the (k−1)^{th} first uplink subframe, and when a value of the 1-bit information is 1, the second indication information indicates that the uplink subframe closest to the receiving time for the i^{th} first downlink subframe is the k^{th} first uplink subframe.

In some embodiments, the transceiver unit is further configured to receive third indication information from the second communication apparatus, where the third indication information indicates a subframe number of a subframe required for sending, and the required subframe is an uplink subframe j closest to the receiving time for the i^{th} first downlink subframe.

In some embodiments, the first information includes the first time difference, and the first time difference is a time difference between a first moment and a second moment; or the first information includes a first moment and a second moment; and the first moment is a moment for receiving the i^{th} first downlink subframe, and the second moment is a sending moment for sending the k^{th} first uplink subframe.

In some embodiments, the transceiver unit is further configured to: send a second uplink frame to the second communication apparatus; and receive a second downlink frame from the second communication apparatus, where the second uplink frame is used to determine second information, and the second information indicates a second time difference between receiving time for receiving an x^{th} third uplink subframe in the second uplink frame and sending time for sending a y^{th} third downlink subframe in the second downlink frame.

In some embodiments, the second information includes the second time difference, and the second time difference includes a sum of an eighth time difference and a ninth time difference; or the second information includes an eighth time difference and a ninth time difference; and the eighth time difference is a time difference between the receiving time for the x^{th} third uplink subframe and sending time for sending a fourth downlink subframe, the sending time for the fourth downlink subframe is closest to the receiving time for the x^{th} third uplink subframe, and the ninth time difference is a time difference between the sending time for the fourth downlink subframe and the sending time for the y^{th} third downlink subframe.

In some embodiments, the second information includes the second time difference, and the second time difference includes a sum of a tenth time difference and an eleventh time difference; or the second information includes a tenth time difference and an eleventh time difference; and the tenth time difference is a time difference between the sending time for the y^{th} third downlink subframe and receiving time for receiving a fourth uplink subframe, the receiving time for the fourth uplink subframe is closest to the sending time for the y^{th} third downlink subframe, and the eleventh time difference is a time difference between the receiving time for the fourth uplink subframe and the receiving time for the x^{th} third uplink subframe.

In some embodiments, the second information includes the second time difference, and the second time difference includes a sum of an eighth time difference, a tenth time difference, and a twelfth time difference; or the second information includes an eighth time difference, a tenth time difference, and a twelfth time difference; and the eighth time difference is a time difference between the receiving time for the x^{th} third uplink subframe and sending time for sending a fourth downlink subframe, the sending time for the fourth downlink subframe is closest to the receiving time for the x^{th} third uplink subframe, the tenth time difference is a time difference between the sending time for the y^{th} third downlink subframe and receiving time for receiving a fourth uplink subframe, the receiving time for the fourth uplink subframe is closest to the sending time for the y^{th} third downlink subframe, and the twelfth time difference is a time difference between the receiving time for the fourth uplink subframe and the sending time for sending the fourth downlink subframe.

In some embodiments, the transceiver unit is further configured to receive fourth indication information from the second communication apparatus, where the fourth indication information indicates a subframe number of the fourth downlink subframe; or the fourth downlink subframe carries a reference signal.

In some embodiments, the second information includes the second time difference, and the second time difference is a time difference between a third moment and a fourth moment; or the first information includes a third moment and a fourth moment; and the third moment is a moment for receiving the x^{th} third uplink subframe, and the fourth moment is a moment for sending the y^{th} third downlink subframe.

In some embodiments, the transceiver unit is further configured to receive first configuration information from a location management network element, where the first configuration information indicates to determine the first information.

According to a fifth aspect, a communication apparatus is provided, where the apparatus includes a transceiver unit, and the transceiver unit is configured to: send a first downlink frame to a first communication apparatus; receive a first uplink frame from the first communication apparatus; receive first information from the first communication apparatus, where the first information indicates a first time difference between receiving time for receiving an i^{th} first downlink subframe in the first downlink frame and sending time for sending a k^{th} first uplink subframe in the first uplink frame; and send the first information to a positioning server, where the first information is used by the positioning server to verify a location of a terminal device.

In some embodiments, the first information includes the first time difference, and the first time difference includes a sum of a third time difference and a fourth time difference; or the first information includes a third time difference and a fourth time difference; and the third time difference is a time difference between the receiving time for the i^{th} first downlink subframe and sending time for sending a second uplink subframe, the sending time for the second uplink subframe is closest to the receiving time for the i^{th} first downlink subframe, and the fourth time difference is a time difference between the sending time for the second uplink subframe and the sending time for the k^{th} first uplink subframe.

In some embodiments, an uplink frame in which the second uplink subframe is located is different from the first uplink frame.

In some embodiments, the first information includes the first time difference, and the first time difference includes a sum of a fifth time difference and a sixth time difference; or the first information includes a fifth time difference and a sixth time difference; and the fifth time difference is a time difference between the sending time for the k^{th} first uplink subframe and receiving time for receiving a second downlink subframe, the receiving time for the second downlink subframe is closest to the sending time for the k^{th} first uplink subframe, and the sixth time difference is a time difference between the receiving time for the i^{th} first downlink subframe and the receiving time for the second downlink subframe.

In some embodiments, the first information includes the first time difference, and the first time difference includes a sum of a third time difference, a fifth time difference, and a seventh time difference; or the first information includes a third time difference, a fifth time difference, and a seventh time difference; and the third time difference is a time difference between the receiving time for the i^{th} first downlink subframe and sending time for sending a second uplink subframe, the sending time for the second uplink subframe is closest to the receiving time for the i^{th} first downlink subframe, the fifth time difference is a time difference between the sending time for the k^{th} first uplink subframe and receiving time for receiving a second downlink subframe, the receiving time for the second downlink subframe is closest to the sending time for the k^{th} first uplink subframe, and the seventh time difference is a time difference between the receiving time for the second downlink subframe and the sending time for the second uplink subframe.

In some embodiments, the transceiver unit is further configured to receive first indication information from the first communication apparatus, where the first indication information indicates a subframe number of the second uplink subframe; or the second uplink subframe carries a reference signal.

In some embodiments, the transceiver unit is further configured to receive second indication information from the first communication apparatus, where the second indication information indicates that an uplink subframe closest to the receiving time for the i^{th} first downlink subframe is the k^{th} first uplink subframe, or indicates that an uplink subframe closest to the receiving time for the i^{th} first downlink subframe is a (k−1)^{th} first uplink subframe.

In some embodiments, the second indication information is 1-bit information, and a value of the 1 bit is 0 or 1; and
when a value of the 1-bit information is 0, the second indication information indicates that the uplink subframe closest to the receiving time for the i^{th} first downlink subframe is the k^{th} first uplink subframe, and when a value of the 1-bit information is 1, the second indication information indicates that the uplink subframe closest to the receiving time for the i^{th} first downlink subframe is the (k−1)^{th} first uplink subframe; or
when a value of the 1-bit information is 0, the second indication information indicates that the uplink subframe closest to the receiving time for the i^{th} first downlink subframe is the (k−1)^{th} first uplink subframe, and when a value of the 1-bit information is 1, the second indication information indicates that the uplink subframe closest to the receiving time for the i^{th} first downlink subframe is the k^{th} first uplink subframe.

In some embodiments, before receiving the second indication information from the first communication apparatus, sending third indication information to the first communication apparatus, where the third indication information indicates a subframe number of a subframe required for sending, and the required subframe is an uplink subframe j closest to the receiving time for the i^{th} first downlink subframe.

In some embodiments, the first information includes the first time difference, and the first time difference is a time difference between a first moment and a second moment; or the first information includes a first moment and a second moment; and the first moment is a moment for receiving the i^{th} first downlink subframe, and the second moment is a sending moment for sending the k^{th} first uplink subframe.

In some embodiments, the transceiver unit is further configured to: receive a second uplink frame from the first communication apparatus; send a second downlink frame to the first communication apparatus; and send second information to the positioning server, where the second information indicates a second time difference between receiving time for receiving an x^{th} third uplink subframe in the second uplink frame and sending time for sending a y^{th} third downlink subframe in the second downlink frame.

In some embodiments, the second information includes the second time difference, and the second time difference includes a sum of an eighth time difference and a ninth time difference; or the second information includes an eighth time difference and a ninth time difference; and the eighth time difference is a time difference between the receiving time for the x^{th} third uplink subframe and sending time for sending a fourth downlink subframe, the sending time for the fourth downlink subframe is closest to the receiving time for the x^{th} third uplink subframe, and the ninth time difference is a time difference between the sending time for the fourth downlink subframe and the sending time for the y^{th} third downlink subframe.

In some embodiments, the second information includes the second time difference, and the second time difference includes a sum of a tenth time difference and an eleventh time difference; or the second information includes a tenth time difference and an eleventh time difference; and the tenth time difference is a time difference between the sending time for the y^{th} third downlink subframe and receiving time for receiving a fourth uplink subframe, the receiving time for the fourth uplink subframe is closest to the sending time for the y^{th} third downlink subframe, and the eleventh time difference is a time difference between the receiving time for the fourth uplink subframe and the receiving time for the x^{th} third uplink subframe.

In some embodiments, the second information includes the second time difference, and the second time difference includes a sum of an eighth time difference, a tenth time difference, and a twelfth time difference; or the second information includes an eighth time difference, a tenth time difference, and a twelfth time difference; and the eighth time difference is a time difference between the receiving time for the x^{th} third uplink subframe and sending time for sending a fourth downlink subframe, the sending time for the fourth downlink subframe is closest to the receiving time for the x^{th} third uplink subframe, the tenth time difference is a time difference between the sending time for the y^{th} third downlink subframe and receiving time for receiving a fourth uplink subframe, the receiving time for the fourth uplink subframe is closest to the sending time for the y^{th} third downlink subframe, and the twelfth time difference is a time difference between the receiving time for the fourth uplink subframe and the sending time for sending the fourth downlink subframe.

In some embodiments, the transceiver unit is further configured to send fourth indication information to the first communication apparatus, where the fourth indication information indicates a subframe number of the fourth downlink subframe; or the fourth downlink subframe carries a reference signal.

In some embodiments, the second information includes the second time difference, and the second time difference is a time difference between a third moment and a fourth moment; or the first information includes a third moment and a fourth moment; and the third moment is a moment for receiving the x^{th} third uplink subframe, and the fourth moment is a moment for sending the y^{th} third downlink subframe.

In some embodiments, the transceiver unit is further configured to receive first configuration information from the positioning server, where the first configuration information indicates to determine the first information; and send the first configuration information to the first communication apparatus.

In some embodiments, the transceiver unit is further configured to receive second configuration information from the positioning server, where the second configuration information indicates to determine the second information.

According to a sixth aspect, a communication apparatus is provided, where the apparatus includes a transceiver unit, and the transceiver unit is configured to: receive first information from a second communication apparatus, where the first information indicates a first time difference between receiving time at which a first communication apparatus receives an i^{th} first downlink subframe in a first downlink frame and sending time at which the first communication apparatus sends a k^{th} first uplink subframe in a first uplink frame; and verify a location of a terminal device based on the first information.

In some embodiments, the first information includes the first time difference, and the first time difference includes a sum of a third time difference and a fourth time difference; or the first information includes a third time difference and a fourth time difference; and the third time difference is a time difference between the receiving time for the i^{th} first downlink subframe and sending time for sending a second uplink subframe, the sending time for the second uplink subframe is closest to the receiving time for the i^{th} first downlink subframe, and the fourth time difference is a time difference between the sending time for the second uplink subframe and the sending time for the k^{th} first uplink subframe.

In some embodiments, an uplink frame in which the second uplink subframe is located is different from the first uplink frame.

In some embodiments, the first information includes the first time difference, and the first time difference includes a sum of a fifth time difference and a sixth time difference; or the first information includes a fifth time difference and a sixth time difference; and the fifth time difference is a time difference between the sending time for the k^{th} first uplink subframe and receiving time for receiving a second downlink subframe, the receiving time for the second downlink subframe is closest to the sending time for the k^{th} first uplink subframe, and the sixth time difference is a time difference between the receiving time for the i^{th} first downlink subframe and the receiving time for the second downlink subframe.

In some embodiments, the first information includes the first time difference, and the first time difference includes a sum of a third time difference, a fifth time difference, and a seventh time difference; or the first information includes a third time difference, a fifth time difference, and a seventh time difference; and the third time difference is a time difference between the receiving time for the i^{th} first downlink subframe and sending time for sending a second uplink subframe, the sending time for the second uplink subframe is closest to the receiving time for the i^{th} first downlink subframe, the fifth time difference is a time difference between the sending time for the k^{th} first uplink subframe and receiving time for receiving a second downlink subframe, the receiving time for the second downlink subframe is closest to the sending time for the k^{th} first uplink subframe, and the seventh time difference is a time difference between the receiving time for the second downlink subframe and the sending time for the second uplink subframe.

In some embodiments, the first information includes the first time difference, and the first time difference is a time difference between a first moment and a second moment; or the first information includes a first moment and a second moment; and the first moment is a moment for receiving the i^{th} first downlink subframe, and the second moment is a sending moment for sending the k^{th} first uplink subframe.

In some embodiments, the transceiver unit is further configured to receive second information from the second communication apparatus, where the second information indicates a second time difference between receiving time at which the second communication apparatus receives an x^{th} third uplink subframe in a second uplink frame and sending time at which the second communication apparatus sends a y^{th} third downlink subframe in a second downlink frame.

In some embodiments, the second information includes the second time difference, and the second time difference includes a sum of an eighth time difference and a ninth time difference; or the second information includes an eighth time difference and a ninth time difference; and the eighth time difference is a time difference between the receiving time for the x^{th} third uplink subframe and sending time for sending a fourth downlink subframe, the sending time for the fourth downlink subframe is closest to the receiving time for the x^{th} third uplink subframe, and the ninth time difference is a time difference between the sending time for the fourth downlink subframe and the sending time for the y^{th} third downlink subframe.

In some embodiments, the second information includes the second time difference, and the second time difference includes a sum of a tenth time difference and an eleventh time difference; or the second information includes a tenth time difference and an eleventh time difference; and the tenth time difference is a time difference between the sending time for the y^{th} third downlink subframe and receiving time for receiving a fourth uplink subframe, the receiving time for the fourth uplink subframe is closest to the sending time for the y^{th} third downlink subframe, and the eleventh time difference is a time difference between the receiving time for the fourth uplink subframe and the receiving time for the x^{th} third uplink subframe.

In some embodiments, the second information includes the second time difference, and the second time difference includes a sum of an eighth time difference, a tenth time difference, and a twelfth time difference; or the second information includes an eighth time difference, a tenth time difference, and a twelfth time difference; and the eighth time difference is a time difference between the receiving time for the x^{th} third uplink subframe and sending time for sending a fourth downlink subframe, the sending time for the fourth downlink subframe is closest to the receiving time for the x^{th} third uplink subframe, the tenth time difference is a time difference between the sending time for the y^{th} third downlink subframe and receiving time for receiving a fourth uplink subframe, the receiving time for the fourth uplink subframe is closest to the sending time for the y^{th} third downlink subframe, and the twelfth time difference is a time difference between the receiving time for the fourth uplink subframe and the sending time for sending the fourth downlink subframe.

In some embodiments, the second information includes the second time difference, and the second time difference is a time difference between a third moment and a fourth moment; or the first information includes a third moment and a fourth moment; and the third moment is a moment for receiving the x^{th} third uplink subframe, and the fourth moment is a moment for sending the y^{th} third downlink subframe.

In some embodiments, the transceiver unit is further configured to send first configuration information and second configuration information to the second communication apparatus, where the first configuration information indicates to determine the first information, and the second configuration information indicates to determine the second information.

According to a seventh aspect, a communication apparatus is provided, and includes a processor. The processor is coupled to a memory, and may be configured to execute instructions in the memory, to implement the method according to any one of the first aspect and the possible implementations of the first aspect. In some embodiments, the communication apparatus further includes the memory. In some embodiments, the communication apparatus further includes a communication interface, and the processor is coupled to the communication interface.

In some embodiments, the communication apparatus is a terminal device. When the communication apparatus is the terminal device, the communication interface may be a transceiver or an input/output interface.

In some embodiments, the communication apparatus is a chip configured in a terminal device. When the communication apparatus is the chip configured in the terminal device, the communication interface may be an input/output interface.

In some embodiments, the transceiver may be a transceiver circuit. Optionally, the input/output interface may be an input/output circuit.

According to an eighth aspect, a communication apparatus is provided, and includes a processor. The processor is coupled to a memory, and may be configured to execute instructions in the memory, to implement the method according to any one of the second aspect and the possible implementations of the second aspect. In some embodiments, the communication apparatus further includes the memory. In some embodiments, the communication apparatus further includes a communication interface, and the processor is coupled to the communication interface.

In some embodiments, the communication apparatus is a network device. When the communication apparatus is the network device, the communication interface may be a transceiver or an input/output interface.

In some embodiments, the communication apparatus is a chip configured in a network device. When the communication apparatus is the chip configured in the network device, the communication interface may be an input/output interface.

In some embodiments, the transceiver may be a transceiver circuit. In some embodiments, the input/output interface may be an input/output circuit.

According to a ninth aspect, a communication apparatus is provided, and includes a processor. The processor is coupled to a memory, and may be configured to execute instructions in the memory, to implement the method according to any one of the third aspect and the possible implementations of the third aspect. In some embodiments, the communication apparatus further includes the memory. In some embodiments, the communication apparatus further includes a communication interface, and the processor is coupled to the communication interface.

In some embodiments, the communication apparatus is a positioning server. When the communication apparatus is the positioning server, the communication interface may be a transceiver or an input/output interface.

In some embodiments, the communication apparatus is a chip configured in a positioning server. When the communication apparatus is the chip configured in the positioning server, the communication interface may be an input/output interface.

According to a tenth aspect, a processor is provided, and includes an input circuit, an output circuit, and a processing circuit. The processing circuit is configured to: receive a signal through the input circuit; and transmit a signal through the output circuit, to enable the processor to perform the method according to any one of the possible implementations of the first aspect to the third aspect.

In an embodiment, the processor may be one or more chips, the input circuit may be an input pin, the output circuit may be an output pin, and the processing circuit may be a transistor, a gate circuit, a trigger, any logic circuit, or the like. An input signal received by the input circuit may be received and input by, for example, but not limited to, a receiver, a signal output by the output circuit may be output to, for example, but not limited to, a transmitter and transmitted by the transmitter, and the input circuit and the output circuit may be a same circuit, where the circuit is used as the input circuit and the output circuit at different moments. Embodiments of the processor and the various circuits are not limited in embodiments of this application.

According to an eleventh aspect, a processing apparatus is provided, and includes a processor and a memory. The processor is configured to: read instructions stored in the memory; receive a signal via a receiver; and transmit a signal via a transmitter, to perform the method according to any one of the possible implementations of the first aspect to the third aspect.

In some embodiments, there are one or more processors, and there are one or more memories.

In some embodiments, the memory may be integrated with the processor, or the memory and the processor are separately disposed.

In an embodiment, the memory may be a non-transitory memory, for example, a read-only memory (ROM). The memory and the processor may be integrated into a same chip, or may be separately disposed on different chips. A type of the memory and a manner of disposing the memory and the processor are not limited in embodiments of this application.

It should be understood that, a related data exchange process such as sending of indication information may be a process of outputting the indication information from the processor, and receiving of capability information may be a process of receiving the input capability information by the processor. In an embodiment, data output by the processor may be output to the transmitter, and input data received by the processor may be from the receiver. The transmitter and the receiver may be collectively referred to as a transceiver.

The processing apparatus in the eleventh aspect may be one or more chips. The processor in the processing apparatus may be implemented by using hardware, or may be implemented by using software. When the processor is implemented by using hardware, the processor may be a logic circuit, an integrated circuit, or the like. When the processor is implemented by using software, the processor may be a general-purpose processor, and is implemented by reading software code stored in the memory. The memory may be integrated into the processor, or may be located outside the processor and exist independently.

According to a twelfth aspect, a computer program product is provided. The computer program product includes a computer program (which may also be referred to as code or instructions). When the computer program is run, a computer is enabled to perform the method according to any one of the possible implementations of the first aspect to the third aspect.

According to a thirteenth aspect, a computer-readable storage medium is provided. The computer-readable storage medium stores a computer program. When the computer program is run on a computer, the method according to any one of the possible implementations of the first aspect to the third aspect is implemented.

According to a fourteenth aspect, a communication system is provided, and includes at least one of the foregoing first communication apparatus, second communication apparatus, and positioning server.

### BRIEF DESCRIPTION OF DRAWINGS

FIG. 1 is a diagram of an architecture of satellite communication;

FIG. 2 is a diagram of a communication system to which an embodiment of this application is applicable;

FIG. 3 is a diagram of transmission round-trip time between UE and a gNB;

FIG. 4 is a diagram of an application scenario of a positioning method;

FIG. 5A and FIG. 5B are a diagram of an application scenario of another positioning method;

FIG. 6 is a schematic flowchart of a communication method 600 according to an embodiment of this application;

FIG. 7 is a diagram of uplink/downlink subframe transmission between UE and a gNB according to an embodiment of this application;

FIG. 8 is another diagram of uplink/downlink subframe transmission between UE and a gNB according to an embodiment of this application;

FIG. 9 is another diagram of uplink/downlink subframe transmission between UE and a gNB according to an embodiment of this application;

FIG. 10 is a block diagram of a communication apparatus 700 according to an embodiment of this application;

FIG. 11 is a block diagram of a communication apparatus 800 according to an embodiment of this application; and

FIG. 12 is a block diagram of a chip system 900 according to an embodiment of this application.

### DESCRIPTION OF EMBODIMENTS

The following describes technical solutions in embodiments of this application with reference to accompanying drawings.

The technical solutions in embodiments of this application may be applied to various communication systems, for example, global system for mobile communications (GSM), a code division multiple access (CDMA) system, a wideband code division multiple access (WCDMA) system, a general packet radio service (GGPRS), a long term evolution (LTE) system, an LTE frequency division duplex (FDD) system, an LTE time division duplex (TDD) system, a universal mobile telecommunications system (UMTS), a worldwide interoperability for microwave access (WiMAX) communication system, a machine to machine (M2M) communication system, a non-terrestrial network (NTN) system, a 5^{th} generation (5G) mobile communication system, a new radio (NR) system, or a future wireless communication system. The NTN system may also be referred to as a satellite communication system. In addition, the non-terrestrial network system may further include a high altitude platform station (HAPS) communication system.

The NTN system refers to a communication network in which an air platform or a space platform is used as a relay node of a transmission device, or a base station. The air platform or the space platform includes, but not limited to, an uncrewed aerial vehicle, a hot air balloon, an airplane, a satellite, and the like.

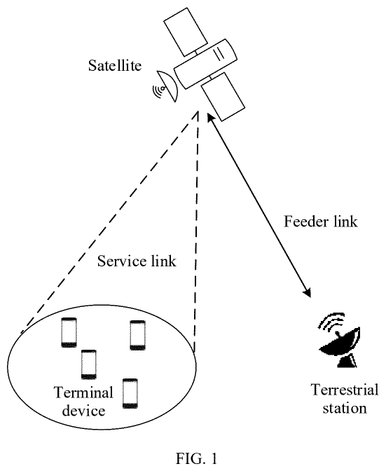

FIG. 1 is a diagram of an architecture of NTN communication. As shown in FIG. 1, satellite communication is used as an example. In this scenario, a ground station (GW), a satellite, user equipment (UE), and the like may be included. A ground station in an NTN system can provide a function similar to that of a gateway in a terrestrial communication system, for example, establishing a connection to UE and communicating with a server. For distinction from the terrestrial communication system, the gateway is referred to as a ground station herein. The ground station also has functions such as monitoring and fault query for a satellite, and packet switching and interface protocol conversion for communication data. The ground station is connected to a core network. A link between the ground station and the satellite is referred to as a feeder link. A link between the satellite and the user equipment is referred to as a service link. Usually, the satellite may have two operating modes, which are respectively a transparent transmission mode and a regenerative mode. In the transparent transmission mode, a data of a terminal device usually reaches the ground station through the satellite, and then reaches a destination through the ground station. Usually, because a distance between the satellite and the terminal device on the ground is relatively long, for example, more than 1000 kilometers, a transmission delay is relatively large when the satellite transmits data in this operating mode. In the regenerative mode, in addition to performing filtering, and frequency and signal amplification on a wireless signal, the satellite may also perform signal demodulation, decoding, data packet switching or routing, and coding and modulation. Therefore, the satellite operating in the regenerative mode basically has some or all functions of a base station in a cellular network.

It should be understood that the user equipment (UE) in embodiments of this application may be referred to as a terminal device, and is a device that provides voice/data connectivity for a user, for example, a handheld device having a wireless connection function, or a vehicle-mounted device. Currently, some examples of the terminal may be a mobile phone (mobile phone), a tablet computer (pad), a computer (for example, a laptop computer or a palmtop computer) having a wireless transceiver function, a mobile internet device (MID), a virtual reality (VR) device, an augmented reality (AR) device, a wireless terminal in industrial control, a wireless terminal in self driving, a wireless terminal in remote medical, a wireless terminal in a smart grid, a wireless terminal in transportation safety, a wireless terminal in a smart city, a wireless terminal in a smart home, a cellular phone, a cordless phone, a session initiation protocol (SIP) phone, a wireless local loop (WLL) station, a personal digital assistant (PDA), a handheld device having a wireless communication function, a computing device, another processing device connected to a wireless modem, a vehicle-mounted device, a wearable device, a terminal device in a 5G network, or a terminal device in a future evolved PLMN.

The wearable device may also be referred to as a wearable intelligent device, and is a general term of wearable devices, such as glasses, gloves, watches, clothes, and shoes, that are developed by applying wearable technologies to intelligent designs of daily wear. The wearable device is a portable device that can be directly worn on the body or integrated into clothes or an accessory of a user. The wearable device is more than a hardware device, and can implement powerful functions through software support, data exchange, and cloud interaction. In a broad sense, wearable intelligent devices include full-featured and large-sized devices that can implement complete or partial functions without depending on smartphones, such as smart watches or smart glasses, and devices that dedicated to only one type of application function and need to work with other devices like smartphones, for example, various smart bands or smart jewelry for monitoring physical signs.

In addition, the terminal device may alternatively be a terminal device in an internet of things (IoT) system. The IoT is an important part of future information technology development. A main technical feature of the IoT is to connect things to a network by using a communication technology, to implement a smart network for human-machine interconnection and thing-thing interconnection. In an IoT technology, massive connections, deep coverage, and power saving of a terminal may be implemented by using, for example, a narrow band (NB) technology.

It should be understood that an example of the NTN communication scenario is described in FIG. 1. In embodiments of this application, an example in which a communication apparatus is a satellite is used. However, the communication apparatus in embodiments of this application is not limited thereto. Alternatively, the communication apparatus in this application may be a ground station, a high altitude platform, an uncrewed aerial vehicle in NTN communication, a terminal device that undertakes a base station function in device-to-device (Device-to-Device, D2D) communication, or the like.

In addition, the communication apparatus in embodiments of this application may be a device configured to communicate with a terminal device. The communication apparatus in embodiments of this application may also be referred to as a network device. The communication apparatus may be a base transceiver station (BTS) in a global system for mobile communications (GSM) or a code division multiple access (CDMA) system, may be a NodeB (NB) in a wideband code division multiple access (WCDMA) system, may be an evolved NodeB (eNB or eNodeB) in an LTE system, or may be a radio controller in a cloud radio access network (CRAN) scenario. Alternatively, the communication apparatus may be a relay station, an access point, a vehicle-mounted device, a wearable device, a communication apparatus in a 5G network, a communication apparatus in a future evolved PLMN network, or the like. This is not limited in embodiments of this application.

It should be understood that a communication apparatus in the wireless communication system may be any device that has a wireless transceiver function. The device includes but is not limited to a base station controller (BSC), a base transceiver station (BTS), or the like; may be one antenna panel or a group of antenna panels (including a plurality of antenna panels) of a base station in a 5G system or the like; or may be a satellite or the like.

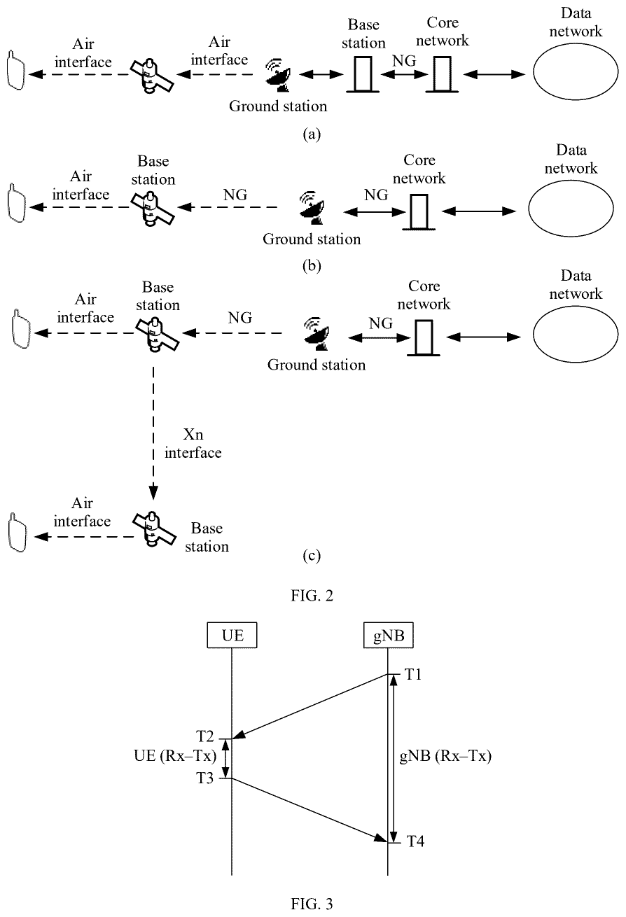

The solutions provided in this application may be applied to a satellite communication scope. For example, members of the 3GPP integrate satellite communication and 5G technologies. FIG. 2 shows a network application architecture of the technology. A terrestrial mobile terminal device UE accesses a network through air interfaces, where the air interfaces may be various types of air interfaces, for example, a 5G air interface. As shown in (a) in FIG. 2, a base station may be deployed on the ground, and is connected to a ground station that communicates with a satellite. Alternatively, as shown in (b) in FIG. 2, a base station may be deployed on a satellite. The satellite is connected to the ground station via a wireless link, the ground station and a terrestrial base station are connected to a core network via a wired or wireless link, and a wireless link may exist between satellites, as shown in (c) in FIG. 2. If the satellite has only a transparent transmission and forwarding function (that is, a corresponding base station is deployed on the ground), only the transparent transmission and forwarding function is implemented between the satellites. If the base station or some base station functions are deployed on the satellite, signaling exchange and user data transmission between base stations may be completed between the satellites. Network elements and interfaces between the network elements in the figure are described below.

For the terminal device, refer to the foregoing descriptions of the terminal device. In addition, the terminal device may access a satellite network through an air interface and initiate a service such as a call or internet access.

The base station mainly provides a wireless access service, schedules a wireless resource for the accessed terminal device, and provides a reliable wireless transmission protocol, data encryption protocol, and the like.

The core network provides services such as user access control, mobility management, session management, user security authentication, and charging. The core network includes a plurality of functional units, and can be divided into a control-plane functional entity and a data-plane functional entity. An access and mobility management function (AMF) is responsible for user access management, security authentication, and mobility management. A user plane unit (UPF) is responsible for managing functions such as user plane data transmission and traffic statistics collection.

The ground station is responsible for forwarding signaling and service data between a satellite base station and a 5G core network.

An air interface is a wireless link between the terminal device and the base station.

An Xn interface is an interface between 5G base stations, and is mainly used for exchanging signaling, for example, handover.

An NG interface is an interface between a 5G base station and a 5G core network, and is mainly used to exchange non-access stratum (non-access stratum, NAS) signaling or other signaling of the core network and user service data.

There are a plurality of existing methods for positioning a terminal device via a terrestrial network, for example, positioning the terminal device based on a delay, a delay difference, a receiving angle, and the like of a reference signal. The following describes several common positioning methods.

### 1. Downlink Time Difference of Arrival (DL-TDOA)

A downlink DL signal used for DL-TDOA may be a positioning reference signal (Positioning reference signal, PRS). UE measures a receive time difference between PRSs from different transmit-receive points (transmit-receive Point, TRP) or gNBs and reports the receive time difference to a positioning server. The positioning server then calculates a location of the UE based on a known location of the TRP or the gNB and the receive time difference between the PRSs.

### 2. Uplink Time Difference of Arrival (UL-TDOA)

In a UL-TDOA positioning technology. UE sends a sounding reference signal (sounding reference signal, SRS). Correspondingly, a plurality of TRPs receive the SRS, and report a relative time difference of arrival to a positioning server. The positioning server then estimates a location of the UE based on measurement of the time difference of arrival of the reference signal and a known location of the TRP.

### 3. Multi-Round Trip Time (Multi-RTT)

The multi-round trip time is transmission round-trip time (RTT) between UE and a plurality of TRPs estimated based on time intervals between sending and receiving signals. As shown in FIG. 3, a base station determines that a time difference between sending a PRS and receiving an SRS is T4−T1=gNB (Tx−Rx), and UE determines that a time difference between receiving the PRS and sending the SRS is a time difference T3−T2=UE (Rx−Tx). Therefore. RTT between the UE and the TRP is equal to gNB (Tx−Rx)−UE (Rx−Tx). Through multiple times of measurement, and sending of a measurement result to a positioning server, the positioning server may obtain a location of the UE through calculation based on the RTT.

A time difference of arrival TDOA positioning technology requires synchronization between a user and the base station, while the multi-RTT allows sending of reference signals between the UE and a plurality of TRPs or gNBs, and the location of the UE can be determined based on data such as a time difference between signal receiving time and signal sending time of the UE, and a time difference between signal receiving time and signal sending time of the gNB. This positioning method is not affected by synchronization precision between base stations.

The following describes a method for calculating RTT between UE and a gNB in a terrestrial network.

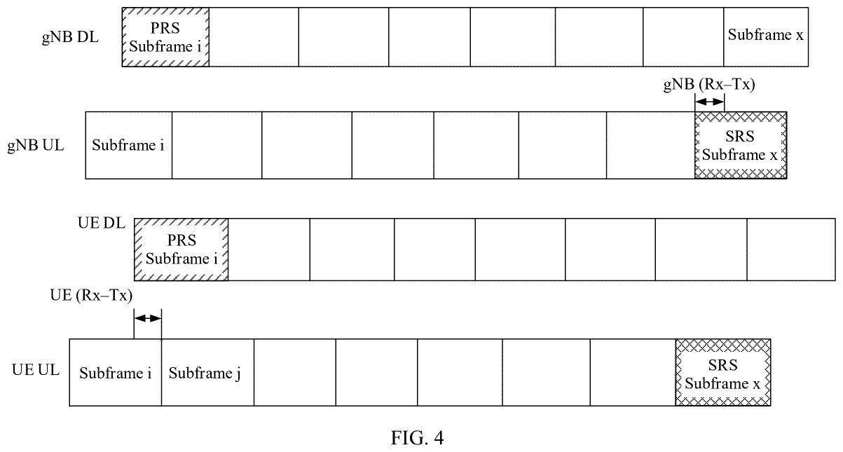

As shown in FIG. 4, a gNB sends a downlink DL subframe i to UE, and the DL subframe i may carry a PRS. The UE needs to send an uplink UL subframe i in advance based on a boundary of the DL subframe i. Advance duration of the UE is a timing advance (timing advance, TA). In this way, the DL subframe i and the UL subframe i are aligned on the gNB side. In an ideal case, the TA may be twice a delay between the UE and the gNB, that is. RTT between the UE and the gNB. If the TA of the UE has a deviation, the gNB needs to determine an actual TA of the UE based on a receive-transmit time difference of the UE and a receive-transmit time difference of the gNB. The receive-transmit time difference of the UE. UE (Rx−Tx), may be a time difference between a moment at which the UE receives the DL subframe i and a moment at which the UE sends a UL subframe j, where the subframe j is closest to the received DL subframe i; and the receive-transmit time difference of the gNB, gNB (Rx−Tx), may be a time difference between a moment at which the gNB receives a UL subframe x and a moment at which the gNB sends a DL subframe y, where the DL subframe y is closest to the received UL subframe x, and the UL subframe x may carry a sounding reference signal (sounding reference signal, SRS). The actual TA of the UE may be a difference between the TA of the UE and |gNB (Rx−Tx)|, where the TA of the UE is a difference between a length of one subframe and UE (Rx−Tx), or is UE (Rx−Tx).

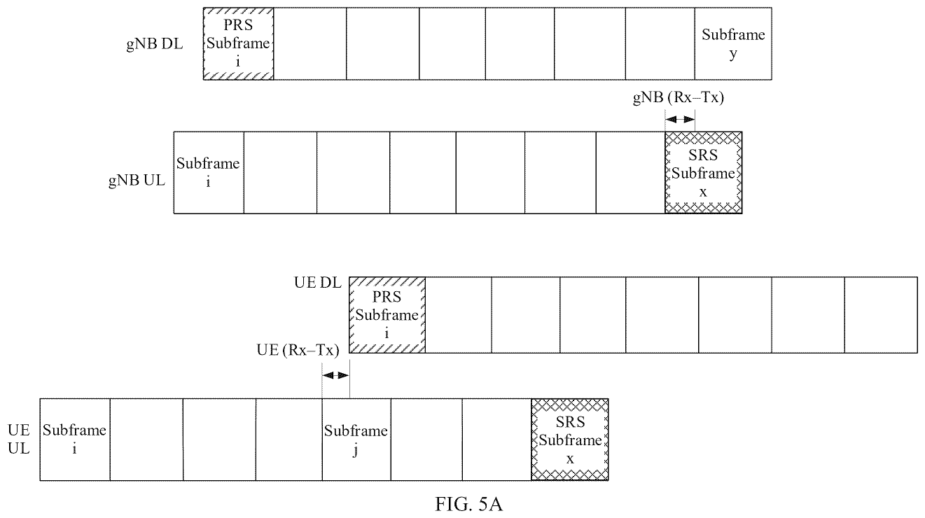

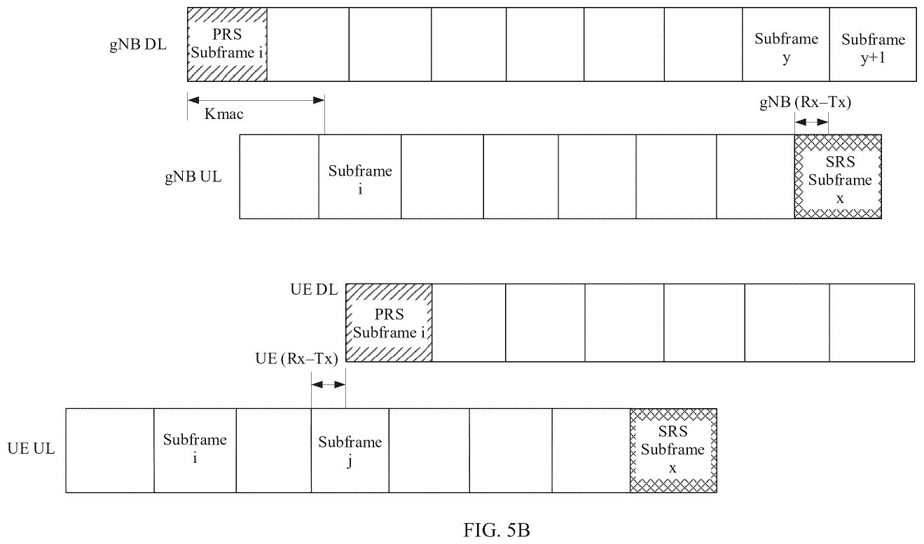

Usually, the timing advance of the UE in the terrestrial network does not exceed one subframe, and a change is small. Therefore, the RTT between the UE and the gNB may be determined based on the foregoing method, and is used by a network side to verify a location of the UE. However, in a satellite communication scenario, a timing advance of the UE is usually large and changes in real time. For example, as shown in FIG. 5A and FIG. 5B, the timing advance of the UE exceeds a length of one subframe, and the UE and the gNB, based on Rx−Tx specified in an existing standard, that is, UE (Tx−Rx) and gNB (Tx−Rx) have same meanings as UE (Tx−Rx) and gNB (Tx−Rx) in FIG. 4, may not be able to calculate a timing advance and transmission round-trip time, where FIG. 5A shows a scenario in which a synchronization point is in the gNB (Kmac=0), FIG. 5B shows a scenario in which a synchronization point is not in the gNB (Kmac≠0), and Kmac is a scheduling deviation provided by the network side. Therefore, the foregoing method may not be applicable to the satellite communication scenario.

In an existing satellite communication scenario, positioning of a ground terminal device is usually implemented by using a dedicated positioning satellite, and the positioning satellite is mainly used by the terminal device to position the terminal device. The terminal device reports location information of the terminal device to a network side. However, the location information reported by the ground terminal device may be tampered with, or a large error may exist in the reported location information due to interference. Therefore, how to implement positioning of the ground terminal device by the network side or verification of the location information reported by the ground terminal device is a problem that needs to be resolved.

In view of this, an embodiment of this application provides a communication method, which may be applied to positioning or location verification of a terminal device in a satellite communication scenario.

For ease of understanding embodiments of this application, the following descriptions are provided.

In embodiments of this application, “at least two” means two or more. The term “and/or” describes an association relationship between associated objects, and indicates that three relationships may exist. For example, A and/or B may indicate the following cases: Only A exists, both A and B exist, and only B exists, where A and B may be singular or plural. In text descriptions of this application, the character “/” generally represents an “or” relationship between associated objects.

It may be understood that various numbers in embodiments of this application are merely used for differentiation for ease of description, and are not used to limit the scope of embodiments of this application. Sequence numbers of the foregoing processes do not mean execution sequences. The execution sequences of the processes should be determined based on functions and internal logic of the processes, and should not constitute any limitation on processes of embodiments of this application.

In embodiments of this application, “first”, “second”, and various numbers are used for differentiation for ease of description, and are not used to limit the scope of embodiments of this application. For example, the terms are used to distinguish between different indication information.

In embodiments of this application, “used to indicate” may include “directly indicate” and “indirectly indicate”. When a piece of indication information indicates A, the indication information may directly indicate A or indirectly indicate A, but it does not indicate that the indication information definitely carries A.

Furthermore, indication manners may vary, for example, but not limited to, the foregoing indication manners and various combinations thereof. For details of the various indication manners, refer to the conventional technology. The details are not described in this specification. It can be learned from the foregoing descriptions that, for example, when a plurality of pieces of information of a same type need to be indicated, different information may be indicated in different manners. In an embodiment, an indication manner may be selected based on a requirement. The selected indication manner is not limited in embodiments of this application. In this way, the indication manner in embodiments of this application should be understood as covering various methods that can enable a to-be-indicated party to learn of to-be-indicated information.

In embodiments of this application, descriptions such as “when”, “in case of”, and “if” all mean that a device performs corresponding processing in an objective situation, are not intended to limit time, do not require that the device should have a determining action during implementation, and do not mean that there are other limitations.

In embodiments of this application, the “indication information” and the “configuration information” may be an explicit indication, such as a direct indication through signaling, or an indication obtained based on a parameter indicated by signaling in combination with another rule or another parameter or obtained through deduction; or may be an implicit indication, such as an indication obtained based on a rule, a relationship, or another parameter or obtained through deduction.

It should be understood that the positioning server in this application is responsible for a position-related information service of a terminal device, including providing assistance information for the terminal device to perform position measurement, or processing position measurement information reported by the terminal device or a base station and calculating final coordinates, a position movement speed, and the like. The positioning server may be a location management network element. For example, in a 5G communication system, the location management network element may be an LMF network element. In a future communication system, the location management network element may still be an LMF network element or have another name. This is not limited in this application. The positioning server may be located in a core network, or may be located in a network device.

It should be understood that the “reference signal used for positioning” in this application is collectively denoted as a “reference signal”, but this does not mean that the “reference signal” includes only a reference signal dedicated for positioning (PRS). In some embodiments, the “reference signal used for positioning” may further include a sounding reference signal (SRS), a demodulation reference signal (DMRS), a tracking reference signal (TRS), a channel state information reference signal (CSI-RS), and the like.

It should be understood that the downlink frame or the uplink frame described in embodiments of this application is merely an example, and the frame may be replaced with a time unit. Similarly, the downlink subframe or the uplink subframe described in this embodiment of this application is merely an example, the subframe may be replaced with a time domain resource, and the time domain resource may alternatively be a slot (slot), a symbol, a mini-subframe, or a mini-slot.

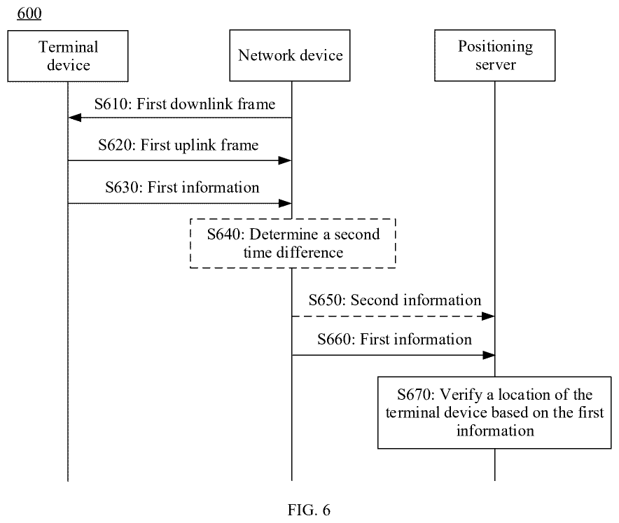

FIG. 6 is a schematic flowchart of an example of a communication method 600 according to an embodiment of this application. The method 600 includes at least the following operations.

S610: A network device (an example of a second communication apparatus) sends a first downlink frame to a terminal device (an example of a first communication apparatus). Correspondingly, the terminal device receives the first downlink frame from the network device.

The first downlink frame includes N first downlink subframes. An i^{th} first downlink subframe in the N first downlink subframes may be used to carry a reference signal, for example, a PRS; or the i^{th} first downlink subframe is configured as a reference signal resource based on configuration information. N is a positive integer, and i is any value from 1 to N.

It may be understood that, when the i^{th} first downlink subframe is configured as the reference signal resource based on the configuration information, the i^{th} first downlink subframe may actually not carry a reference signal, and the network device and/or the terminal device may determine, based on a boundary of the i^{th} first downlink subframe, sending time or receiving time for the i^{th} first downlink subframe. In this way, signaling overheads can be reduced.

S620: The terminal device sends a first uplink frame to the network device. Correspondingly, the network device receives the first uplink frame from the terminal device.

The first uplink frame includes N first uplink subframes. A k^{th} first uplink subframe in the N first uplink subframes may be used to carry a reference signal, for example, an SRS; or the k^{th} first uplink subframe is configured as a reference signal resource based on configuration information. N is a positive integer, and k is any value from 1 to N.

S630: The terminal device sends first information to a positioning server. Correspondingly, the positioning server receives the first information from the terminal device.

For example, the terminal device may send the first information to the positioning server via the network device.

The first information indicates a first time difference between the receiving time at which the terminal device receives the i^{th} first downlink subframe and the sending time at which the terminal device sends the k^{th} first uplink subframe. For example, the first time difference may indicate a receive-transmit time difference of the terminal device in a satellite communication scenario.

The first information may be any one of the following examples.

### EXAMPLE #1

The first information includes the first time difference, and the first time difference includes a sum of a third time difference and a fourth time difference. For example, the terminal device may separately determine the third time difference and the fourth time difference, and determine the sum of the third time difference and the fourth time difference.

Alternatively, the first information includes a third time difference and a fourth time difference. In an embodiment, the terminal device sends the third time difference and the fourth time difference to the network device, so that the network device or the positioning server (the terminal device sends the third time difference and the fourth time difference to the positioning server via the network device) can determine the first time difference based on the third time difference and the fourth time difference, and the first time difference may include a sum of the third time difference and the fourth time difference.

The third time difference may be a time difference between the receiving time at which the terminal device receives the i^{th} first downlink subframe and sending time at which the terminal device sends a second uplink subframe, the sending time for the second uplink subframe is closest to the receiving time for the i^{th} first downlink subframe, and the fourth time difference is a time difference between the sending time for the second uplink subframe and the sending time for the k^{th} first uplink subframe.

In an example, the second uplink subframe may be a subframe (for example, a j^{th} first uplink subframe) in the first uplink frame. That is, in this example, the fourth time difference may be a time difference between the k^{th} first uplink subframe and the j^{th} first uplink subframe in the first uplink frame.

In some embodiments, when the second uplink subframe is a subframe in the first uplink frame, the first information may further include a subframe quantity (a subframe quantity #1) between the k^{th} first uplink subframe and the second uplink subframe; or the first information may further include a subframe number (a subframe number #1) of the k^{th} first uplink subframe and a subframe number (a subframe number #2) of the second uplink subframe. Therefore, the network device may determine the fourth time difference based on the subframe quantity #1 and a length of the first uplink subframe; or determine the subframe quantity between the k^{th} first uplink subframe and the second uplink subframe based on the subframe number #1 and the subframe number #2, and further determine the fourth time difference.

In another example, the second uplink subframe is a j^{th} subframe in an uplink frame #1, a frame number of the uplink frame #1 is different from a frame number of the first uplink frame, and a start moment of the uplink frame #1 may be earlier than or later than that of the first uplink frame. In other words, in this example, the fourth time difference may be a time difference between the sending time for sending the k^{th} first uplink subframe in the first uplink frame and sending time for the j^{th} subframe in the uplink frame #1.

It should be understood that the receiving time for the i^{th} first downlink subframe may be a moment at which the terminal device receives the i^{th} first downlink subframe; or the receiving time for the i^{th} first downlink subframe is a start moment (a start point) at which the terminal device detects the i^{th} first downlink subframe; or the receiving time for the i^{th} first downlink subframe is first-path arrival time at which the terminal device detects the i^{th} first downlink subframe.

For example, values of i and k may be specified in a protocol, or the network device may send the values of i and k to the terminal device by using broadcast or unicast signaling. For example, the values of i and k may be carried in a system information block 1 (system information block 1, SIB1), downlink control information (downlink control information, DCI), radio resource control (radio resource control, RRC) signaling, uplink feedback signaling, or the like.

In some embodiments, the terminal device may further determine the i^{th} first downlink subframe based on a type (for example, a reference signal or data) of information carried in the downlink subframe, content (for example, content specified in a protocol), a channel carrying the downlink subframe, or a format of the channel.

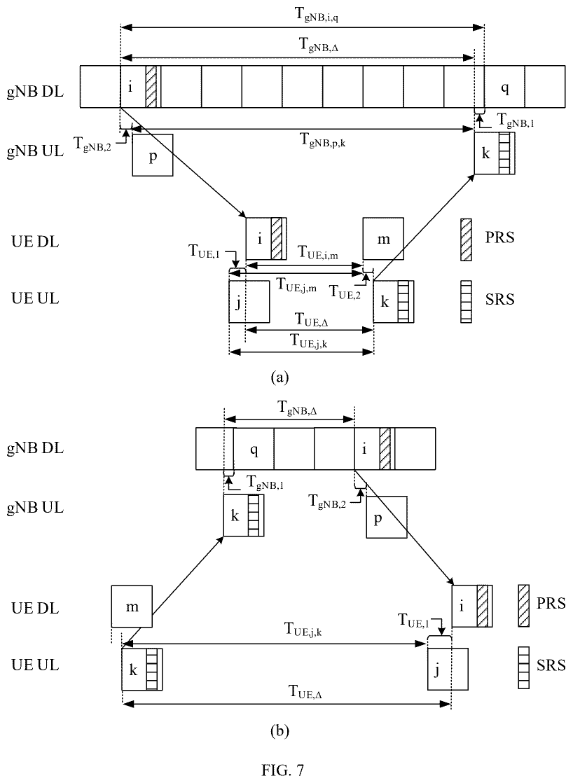

For example, as shown in (a) in FIG. 7, the first time difference may be a time difference T_{UE,Δ} between receiving time for a subframe i (an example of the i^{th} first downlink subframe) in a UE downlink (downlink. DL) frame (an example of the first downlink frame) and sending time for a subframe k (an example of the k^{th} first downlink subframe) in a UE uplink (uplink, UL) frame (an example of the first uplink frame); the third time difference may be a time difference T_{UE,1} between the receiving time for the subframe i in the UE DL frame and sending time for a subframe j (an example of the second uplink subframe) in the UE UL frame, and the sending time for the subframe j is closest to the receiving time for the subframe i; and the fourth time difference may be a time difference T_{UE,j,k} between the sending time for the subframe j and the sending time for the subframe k. The first time difference, the third time difference, and the fourth time difference satisfy: T_{UE,Δ}=T_{UE,1}+T_{UE,j,k}.

### EXAMPLE #2

The first information includes the first time difference, and the first time difference includes a sum of a fifth time difference and a sixth time difference; or the first information includes a fifth time difference and a sixth time difference.

The fifth time difference is a time difference between the sending time at which the terminal device sends the k^{th} first uplink subframe and receiving time at which the terminal device receives a second downlink subframe, the receiving time for the second downlink subframe is closest to the sending time for the k^{th} first uplink subframe, and the sixth time difference is a time difference between the receiving time for the second downlink subframe and the receiving time for the i^{th} first downlink subframe.

The second downlink subframe may be a subframe in the first downlink frame, for example, an m^{th} first downlink subframe in the first downlink frame.

For a manner in which the terminal device determines the values of i and k, refer to the descriptions in Example #1. Details are not described again. The terminal device may determine the receiving time for the second downlink subframe based on the receiving time for the i^{th} first downlink subframe. For example, after determining the receiving time for the i^{th} first downlink subframe, the terminal device may determine, based on the receiving time for the i^{th} first downlink subframe and a subframe length of the first downlink subframe, the receiving time for another first downlink subframe in the first downlink frame. Therefore, receiving time for a downlink subframe closest to the receiving time for the k^{th} first uplink subframe, that is, the receiving time for the second downlink subframe, is determined.

For example, as shown in (a) in FIG. 7, the fifth time difference may be a time difference T_{UE,2} between sending time for a subframe k in a UE UL frame and receiving time for a subframe m (an example of the second downlink subframe) in a UE DL frame, the receiving time for the subframe m is closest to the sending time for the subframe k, and the sixth time difference may be a time difference T_{UE,i,m} between the receiving time for the subframe m and the receiving time for a subframe i in the UE DL frame. The first time difference, the fifth time difference, and the sixth time difference satisfy: T_{UE,Δ}=T_{UE,2}+T_{UE,i,m}.

### EXAMPLE #3

The first information includes the first time difference, and the first time difference includes a sum of a third time difference, a fifth time difference, and a seventh time difference; or the first information includes a third time difference, a fifth time difference, and a seventh time difference.

For the third time difference and the fifth time difference, respectively refer to the descriptions in Example #1 and Example #2. The seventh time difference is a time difference between the receiving time for the second downlink subframe and the sending time for the second uplink subframe. For the second uplink subframe and the second downlink subframe, respectively refer to the descriptions in Example #1 and Example #2.

For example, as shown in (a) in FIG. 7, the third time difference may be a time difference T_{UE,1} between receiving time for a subframe i in a UE DL frame and sending time for a subframe j (an example of a second uplink subframe) in a UE UL frame, the sending time for the subframe j is closest to the receiving time for the subframe i, the fifth time difference may be a time difference T_{UE,2} between sending time for a subframe k in the UE UL frame and receiving time for a subframe m (an example of the second downlink subframe) in the UE DL frame, and the seventh time difference may be a time difference T_{UE,j,m} between the receiving time for the subframe m and the sending time for the subframe j. The first time difference, the fifth time difference, and the sixth time difference satisfy: T_{UE,Δ}=T_{UE,1}+T_{UE,2}+T_{UE,j,m}.

For a description in which the terminal device determines sending time for each uplink subframe and receiving time for each downlink subframe, refer to the descriptions in Example #1 and Example #2. Details are not described again.

### EXAMPLE #4

The first information includes the first time difference, and the first time difference may be a time difference between a first moment and a second moment; or the first information includes a first moment and a second moment.

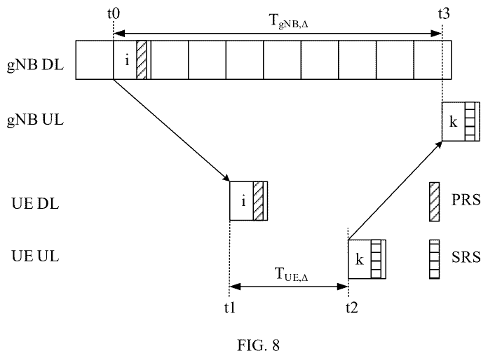

The first moment is a moment at which the terminal device receives the i^{th} first downlink subframe, and the second moment is a sending moment at which the terminal device sends the k^{th} first uplink subframe. As shown in FIG. 8, the first moment may be a receiving moment t1 for a subframe i in a UE DL frame, and the second moment may be a sending moment t2 for a subframe k in a UE UL frame. That is, the first time difference, the first moment, and the second moment satisfy: T_{UE,Δ}=t2=t1.

For a specific manner in which the terminal device determines sending time for each uplink subframe and receiving time for each downlink subframe, refer to the descriptions in Example #1 and Example #2. Details are not described again.

It should be understood that the foregoing example is described by using an example in which the receiving time at which the terminal device receives the i^{th} first downlink subframe is earlier than the sending time at which the terminal device sends the k^{th} first uplink subframe. This application is not limited thereto. In some embodiments, the sending time for the k^{th} first uplink subframe may alternatively be earlier than the receiving time for the i^{th} first downlink subframe, as shown in (b) in FIG. 7.

For example, the first time difference in Example #1 is a sum of the third time difference and the fourth time difference. The first time difference T_{UE,Δ}, the third time difference T_{UE,1}, and the fourth time difference T_{UE,j,k} are respectively shown in (b) in FIG. 7.

In Example #2 to Example #4, for a manner in which the terminal device determines the values of i and k, refer to the descriptions in Example #1. Details are not described again.

In some embodiments, the method further includes: The terminal device sends first indication information to the network device. The first indication information indicates a subframe number of the second uplink subframe.

The subframe number of the second uplink subframe may be used by the network device to determine a second time difference. The second time difference indicates a time difference between receiving time at which the network device receives an uplink subframe from the terminal device and sending time at which the network device sends a downlink subframe. For example, the second time difference may be a receive-transmit time difference of the network device in a satellite communication scenario. For content and a determining manner of the second time difference, refer to the description in S640.

For example, the first indication information may be carried in RRC signaling, media access control control element (MAC CE) signaling, or uplink control information (UCI), or the first information may be carried in other uplink information. A manner of sending the first information is not limited in this application.

For example, as described in Example #1, after the terminal device determines that an uplink subframe closest to the receiving time for the i^{th} first downlink subframes is the j^{th} first uplink subframe (an example of the second uplink subframe), the terminal device sends a subframe number of the j^{th} first uplink subframe to the network device.

When the terminal device sends the subframe number of the second uplink subframe to the network device, the first time difference may alternatively include only the third time difference. In other words, the first information may include the first time difference, and the first time difference is a time difference between the i^{th} first downlink subframe and the second uplink subframe, for example, the third time difference in Example #1.

The representation of the first information may be denoted as Example #5.

In other words, the first time difference (the receive-transmit time difference of the terminal device) may be shown in any one of Example #1 to Example #5. When the first time difference is shown in Example #5, the terminal device may send the first indication information to the network device.

In some embodiments, the network side may further configure the second uplink subframe to carry a reference signal, or configure the second uplink subframe as a reference signal resource (actually, the second uplink subframe may not carry a reference signal).

It should be understood that the terminal device may report a timing advance TA to the network device, so that the network side can learn of an uplink subframe (for example, the j^{th} first uplink subframe) closest to the i^{th} first downlink subframe, and the network side may configure the j^{th} first subframe to carry a reference signal, or configure the j^{th} first subframe as a reference signal resource. When the second uplink subframe carries a reference signal or is configured as a reference signal resource, the first time difference is shown in Example #5.

It may be understood that, when the second uplink subframe carries a reference signal or is a reference signal resource, the network device may determine, by detecting the reference signal or a boundary of the second uplink subframe, the receiving time for the second uplink subframe. In this case, the terminal device may not send the first indication information.

It can be learned from the foregoing description that, when the terminal device reports the TA, the network side may learn of the uplink subframe closest to the receiving time for the i^{th} first downlink subframe, for example, the j^{th} first uplink subframe. In addition, the terminal device may determine the uplink subframe (denoted as a subframe x) closest to the receiving time for the i^{th} first downlink subframe.

The subframe x determined by the terminal device may be the j^{th} first uplink subframe, or may be a subframe adjacent to the j^{th} first uplink subframe, for example, a (j−1)^{th} first uplink subframe.

In some embodiments, the method further includes: The terminal device sends second indication information to the network device. The second indication information indicates that the uplink subframe closest to the receiving time for the i^{th} first downlink subframe is the j^{th} first uplink subframe; or indicates that the uplink subframe closest to the receiving time for the i^{th} first downlink subframe is the (j−1)^{th} first uplink subframe.

In some embodiments, the uplink subframe closest to the receiving time for the i^{th} first downlink subframe may be the k^{th} first uplink subframe, that is, j=k.

For example, the second indication information is 1-bit information, and a value of the 1-bit is 0 or 1.

When a value of the 1-bit information is 0, the second indication information indicates that the uplink subframe closest to the receiving time for the i^{th} first downlink subframe is the j^{th} first uplink subframe, and when a value of the 1-bit information is 1, the second indication information indicates that the uplink subframe closest to the receiving time for the i^{th} first downlink subframe is the (j−1)^{th} first uplink subframe.

Alternatively, when a value of the 1-bit information is 0, the second indication information indicates that the uplink subframe closest to the receiving time for the i^{th} first downlink subframe is the (j−1)^{th} first uplink subframe, and when a value of the 1-bit information is 1, the second indication information indicates that the uplink subframe closest to the receiving time for the i^{th} first downlink subframe is the j^{th} first uplink subframe.

In some embodiments, before the terminal device sends the second indication information to the network device, the terminal device may further receive third indication information from the network device. The third indication information indicates a subframe number of a subframe required for sending, and the required subframe is an uplink subframe closest to the receiving time for the i^{th} first downlink subframe. For example, the required subframe number is the subframe number of the j^{th} first uplink subframe.

In some embodiments, the method further includes:

S640: The network device determines the second time difference.

The second time difference is a time difference between receiving time at which the network device receives an x^{th} third uplink subframe and sending time at which the network device sends the y^{th} third downlink subframe.

The receiving time for the x^{th} third uplink subframe may be a receiving moment at which the network device receives the x^{th} third uplink subframe; or may be a start moment (a start point) at which the network device detects the x^{th} third uplink subframe.

The x^{th} third uplink subframe may be used to carry a reference signal, for example, an SRS; or the x^{th} third uplink subframe is configured as a reference signal resource based on configuration information. For a manner of determining the values of x and y, refer to the manner of determining the values of i and k in S610. Details are not described again.

In an example, the third uplink subframe is a subframe in the first uplink frame, and in some embodiments, x=k; and the third downlink subframe is a subframe in the first downlink frame, and in some embodiments, y=i.

In another example, the third uplink subframe is a subframe in a second uplink frame, and the second uplink frame is different from the first uplink frame; and the third downlink subframe is a subframe in a second downlink frame, and the second downlink frame is different from the first downlink frame.

In this example, before the network device determines the second time difference, the method further includes: The network device receives the second uplink frame from the terminal device; and the network device sends the second downlink frame to the terminal device.

In some embodiments, the method further includes:

S650: The network device sends second information to the positioning server. Correspondingly, the positioning server receives the second information from the network device.

The second information includes the second time difference. The second information may be any one of the following examples.

### EXAMPLE #1

The second information includes the second time difference, and the second time difference includes a sum of an eighth time difference and a ninth time difference; or the second information includes an eighth time difference and a ninth time difference.

The eighth time difference is a time difference between the receiving time for the x^{th} third uplink subframe and sending time for sending a fourth downlink subframe, the sending time for the fourth downlink subframe is closest to the receiving time for the x^{th} third uplink subframe, and the ninth time difference is a time difference between the sending time for the fourth downlink subframe and the sending time for the y^{th} third downlink subframe.

For example, as shown in (a) in FIG. 7, the second time difference may be a time difference between receiving time for a subframe k (an example of the x^{th} third uplink subframe) in a gNB UL frame and sending time for a subframe i (an example of the y^{th} third downlink subframe) in a gNB DL frame, and is denoted as T_{gNB,Δ}; the eighth time difference may be a time difference between the receiving time for the subframe k in the gNB UL frame and sending time for a subframe q (an example of the fourth downlink subframe) in the gNB DL frame, and is denoted as T_{gNB,1}, and the sending time for the subframe q is closest to the receiving time for the subframe k; and the ninth time difference may be a time difference between the sending time for the subframe i and the sending time for the subframe q, and is denoted as T_{UE,i,q}. The second time difference, the eighth time difference, and the ninth time difference satisfy: T_{gNB,Δ}=T_{gNB,1}+T_{UE,i,q}.

### EXAMPLE #2

The second information includes the second time difference, and the second time difference includes a sum of a tenth time difference and an eleventh time difference; or the second information includes a tenth time difference and an eleventh time difference.

The tenth time difference is a time difference between the sending time for the y^{th} third downlink subframe and receiving time for receiving a fourth uplink subframe, the receiving time for the fourth uplink subframe is closest to the sending time for the y^{th} third downlink subframe, and the eleventh time difference is a time difference between the receiving time for the fourth uplink subframe and the receiving time for the x^{th} third uplink subframe.

For example, as shown in (a) in FIG. 7, the tenth time difference may be a time difference between sending time for a subframe i (an example of the y^{th} third downlink subframe) in a gNB DL frame and receiving time for a subframe p (an example of the fourth uplink subframe) in a gNB UL frame, and is denoted as T_{gNB,2}; and the eleventh time difference may be a time difference between the receiving time for the subframe p in the gNB UL frame and receiving time for a subframe k in the gNB UL frame, and is denoted as T_{gNB,p,k}, and the receiving time for the subframe p is closest to the sending time for the subframe i. The second time difference, the tenth time difference, and the eleventh time difference satisfy: T_{gNB,Δ}=T_{gNB,2}+T_{UE,p,k}.

### EXAMPLE #3

The second information includes the second time difference, and the second time difference includes a sum of an eighth time difference, a tenth time difference, and a twelfth time difference; or the second information includes an eighth time difference, a tenth time difference, and a twelfth time difference.

For the eighth time difference and the tenth time difference, respectively refer to the descriptions in Example #1 and Example #2. The twelfth time difference is a time difference between the receiving time for the fourth uplink subframe and the sending time for sending the fourth downlink subframe.

For example, as shown in (a) in FIG. 7, the eighth time difference may be a time difference between receiving time for a subframe k in a gNB UL frame and sending time for a subframe q (an example of the fourth downlink subframe) in a gNB DL frame, and is denoted as T_{gNB,1}; the tenth time difference may be a time difference between sending time for a subframe i (an example of the y^{th} third downlink subframe) in the gNB DL frame and receiving time for a subframe p (an example of the fourth uplink subframe) in the gNB UL frame, and is denoted as T_{gNB,2}; the twelfth time difference may be a time difference between the receiving time for the subframe p in the gNB UL frame and the sending time for the subframe q in the gNB UL frame, and is denoted as T_{gNB,p,q}; and the receiving time for the subframe p is closest to the sending time for the subframe i, and the sending time for the subframe q is closest to the receiving time for the subframe k. The second time difference, the eighth time difference, the tenth time difference, and the eleventh time difference satisfy: T_{gNB,Δ}=T_{gNB,1}+T_{gNB,2}+T_{UE,p,k}.

### EXAMPLE #4

The second information includes the second time difference, and the second time difference is a time difference between a third moment and a fourth moment; or the first information includes a third moment and a fourth moment.

The third moment is a moment for receiving the x^{th} third uplink subframe, and the fourth moment is a moment for sending the y^{th} third downlink subframe. As shown in FIG. 8, the third moment may be a receiving moment t3 for a subframe k in a gNB UL frame, and the fourth moment may be a sending moment t0 for a subframe i in a gNB DL frame. That is, the second time difference, the third moment, and the fourth moment satisfy: T_{gNB,Δ}=t3−t0.

For a description in which the terminal device determines sending time for each uplink subframe and receiving time for each downlink subframe, refer to a determining manner of the terminal device, for example, descriptions in Example #1 and Example #2 in S630. Details are not described again.

### EXAMPLE #5

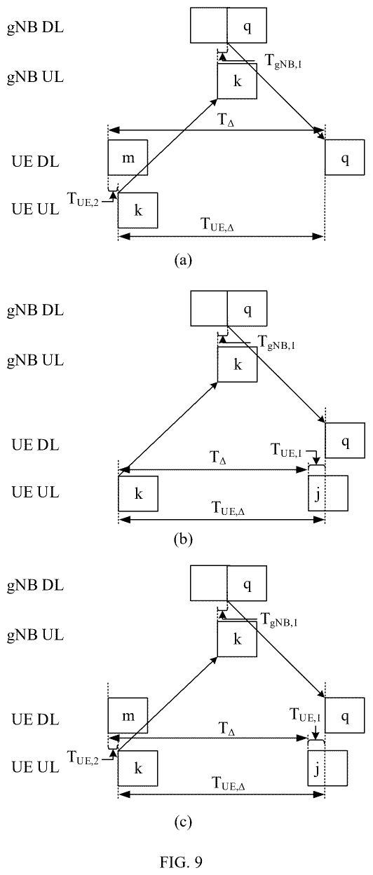

The second time difference includes an eighth time difference, and the eighth time difference may be a time difference between the receiving time for the x^{th} third uplink subframe and the sending time for the fourth downlink subframe. For example, as shown in FIG. 9, the eighth time difference is a time difference between receiving time for a subframe k in a gNB UL frame and sending time for a subframe q (an example of the fourth downlink subframe) in a gNB DL frame, and is denoted as T_{gNB,1}. That is, T_{gNB,Δ}=T_{gNB,1}.

The method further includes: The network device sends fourth indication information to the terminal device, where the fourth indication information indicates a subframe number of the fourth downlink subframe. In this example, the terminal device may further determine the first time difference based on the subframe number of the fourth downlink subframe.

For example, as shown in (a) in FIG. 9, the terminal device may determine that the first time difference is a sum of a time difference #1 and a time difference #2, or the first time difference includes a time difference #1 and a time difference #2. The time difference #1 is a time difference between sending time for a subframe k in a UE UL frame and receiving time for a subframe m in a UE DL frame, and is denoted as T_{UE,2}; and the time difference #2 is a time difference between the receiving time for the subframe m and receiving time for a subframe q in the UE DL, and is denoted as T_{Δ}. The first time difference T_{UE,Δ}, the time difference #1, and the time difference #2 satisfy: T_{UE,Δ}=T_{UE,2}+T_{Δ}.

For another example, as shown in (b) in FIG. 9, the terminal device may determine that the first time difference is a sum of a time difference #3 and a time difference #4, or the first time difference includes a time difference #3 and a time difference #4. The time difference #3 is a time difference between sending time for a subframe j in a UE UL frame and receiving time for a subframe q in a UE DL frame, and is denoted as T_{UE,1}; and the time difference #4 is a time difference between sending time for a subframe k and the sending time for the subframe j, and is denoted as T_{Δ}. The first time difference T_{UE,Δ}, the time difference #1, and the time difference #2 satisfy: T_{UE,Δ}=T_{UE,1}+T_{Δ}.

For another example, as shown in (c) in FIG. 9, the terminal device may determine that the first time difference is a sum of a time difference #1, a time difference #3, and a time difference #5, or the first time difference includes a time difference #1, a time difference #3, and a time difference #5. The time difference #5 is a time difference between receiving time for a subframe m and sending time for a subframe j, and is denoted as T_{Δ}. The first time difference T_{UE,Δ}, the time difference #1, and the time difference #2 satisfy: T_{UE,Δ}=T_{UE,2}+T_{UE,1}+T_{Δ}.

Alternatively, the network side may further configure the fourth downlink subframe to carry a reference signal, for example, a PRS. It should be understood that the network side may determine the fourth downlink subframe based on the TA reported by the UE, and configure the fourth downlink subframe to carry the reference signal.

S660: The network device sends the first information to the positioning server. Correspondingly, the positioning server receives the first information from the network device.

For example, after receiving the first information from the terminal device, the network device sends the first information to the terminal device.

For example, the network device may send the first information and/or the second information to the positioning server in response to a request message of the positioning server; or the network device may send the first information and/or the second information to the positioning server based on configuration information. The first information and the second information may be sent separately or together. A manner of sending the first information and the second information is not limited in this application. In addition, when the first information and the second information are separately sent, a sequence of sending the first information and the second information is not limited.

S670: The positioning server verifies a location of the terminal device based on the first information.

For example, the positioning server may verify the location of the terminal device based on the first information and the second information.

In an embodiment, the network device may determine RTT between the terminal device and the network device, and the positioning server verifies the location of the terminal device based on the RTT. For a manner in which the positioning server verifies the location of the terminal device based on the RTT, refer to existing related descriptions. The RTT may be determined based on the first time difference and the second time difference. For example, RTT=T_{gNB,Δ}−T_{UE,Δ}.

It should be understood that the first time difference may be the first time difference described in any one of Example #1 to Example #5 in S630, and the second time difference may be the second time difference described in any one of Example #1 to Example #5 in S650. The first time differences in Example #1 to Example #5 in S630 respectively correspond to the second time differences in Example #1 to Example #5 in S650. This is not limited in this application.

In some embodiments, the network side (for example, the positioning server) may further send first configuration information and second configuration information to the terminal device and the network device respectively. The first configuration information is used to configure the terminal device to send the first information, and the second configuration information is used to configure the network device to send the second information.

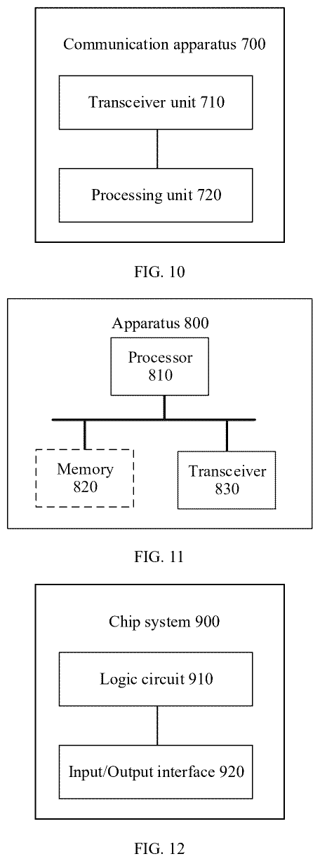

The communication method provided in embodiments of this application is described above in detail with reference to FIG. 6 to FIG. 9. The following describes in detail a communication apparatus provided in embodiments of this application with reference to FIG. 10 to FIG. 12. It should be understood that descriptions of apparatus embodiments correspond to the descriptions of the method embodiments. Therefore, for content that is not described in detail, refer to the method embodiments. For brevity, details are not described herein again.

FIG. 10 is a diagram of a communication apparatus 700 according to an embodiment of this application. The apparatus 700 includes a transceiver unit 710. The transceiver unit 710 may be configured to implement a corresponding communication function. The transceiver unit 710 may also be referred to as a communication interface or a communication unit.

In some embodiments, the apparatus 700 may further include a processing unit 720, where the processing unit 720 may be configured to perform data processing.

In some embodiments, the apparatus 700 further includes a storage unit. The storage unit may be configured to store instructions and/or data. The processing unit 720 may read the instructions and/or the data in the storage unit, to enable the apparatus to implement actions of different devices in the foregoing method embodiments.

n a possible design, the apparatus 700 may be the terminal device in the foregoing embodiments, or may be a component (for example, a chip) of the terminal device. The apparatus 700 may implement the operations or procedures performed by the terminal device in the foregoing method embodiments. The transceiver unit 710 may be configured to perform a receiving/sending-related operation of the terminal device in the foregoing method embodiments, for example, a receiving/sending-related operation of the terminal device in the embodiment shown in FIG. 6. The processing unit 720 may be configured to perform a processing-related operation of the terminal device in the foregoing method embodiments, for example, a processing-related operation of the terminal device in the embodiment shown in FIG. 6.

In another possible design, the apparatus 700 may be the network device in the foregoing embodiments, or may be a component (such as a chip) of the network device. The apparatus 700 may implement operations or procedures performed by the network device in the foregoing method embodiments. The transceiver unit 710 may be configured to perform a receiving/sending-related operation of the network device in the foregoing method embodiments, for example, a receiving/sending-related operation of the network device in the embodiment shown in FIG. 6. The processing unit 720 may be configured to perform a processing-related operation of the network device in the foregoing method embodiments, for example, a processing-related operation of the network device in the embodiment shown in FIG. 6.

In another possible design, the apparatus 700 may be the positioning server in the foregoing embodiments, or may be a component (for example, a chip) of the positioning server. The apparatus 700 may implement operations or procedures performed by the positioning server in the foregoing method embodiments. The transceiver unit 710 may be configured to perform a receiving/sending-related operation of the positioning server in the foregoing method embodiments, for example, a receiving/sending-related operation of the positioning server in the embodiment shown in FIG. 6. The processing unit 720 may be configured to perform a processing-related operation of the positioning server in the foregoing method embodiments, for example, a processing-related operation of the positioning server in the embodiment shown in FIG. 6.

FIG. 11 is a block diagram of a communication apparatus 800 according to an embodiment of this application. The apparatus 800 includes a processor 810, and the processor 810 is coupled to a memory 820. In some embodiments, the apparatus further includes the memory 820. The memory 820 is configured to store a computer program or instructions and/or data. The processor 810 is configured to execute the computer program or the instructions stored in the memory 820, or read data stored in the memory 820, to perform the method in the foregoing method embodiments.

In some embodiments, there are one or more processors 810.

In some embodiments, there are one or more memories 820.

In some embodiments, the memory 820 and the processor 810 are integrated together, or are disposed separately.

In some embodiments, as shown in FIG. 11, the apparatus 800 further includes a transceiver 830. The transceiver 830 is configured to: receive and/or send a signal. For example, the processor 810 is configured to control the transceiver 830 to receive and/or send the signal.

In a solution, the apparatus 800 is configured to implement operations performed by the terminal device in the foregoing method embodiments.

For example, the processor 810 is configured to execute the computer program or the instructions stored in the memory 820, to implement related operations of the terminal device in the foregoing method embodiments, for example, the method performed by the terminal device in the embodiment shown in FIG. 6.

In another solution, the apparatus 800 is configured to implement operations performed by the network device in the foregoing method embodiments.

For example, the processor 810 is configured to execute the computer program or the instructions stored in the memory 820, to implement related operations of the network device in the foregoing method embodiments, for example, the method performed by the network device in the embodiment shown in FIG. 6.

In another solution, the apparatus 800 is configured to implement operations performed by the positioning server in the foregoing method embodiments.

For example, the processor 810 is configured to execute the computer program or the instructions stored in the memory 820, to implement related operations of the positioning server in the foregoing method embodiments, for example, the method performed by the positioning server in the embodiment shown in FIG. 6.

In some embodiments, operations of the foregoing methods may be implemented by using an integrated logic circuit of hardware in the processor 810 or instructions in a software form. The method disclosed with reference to embodiments of this application may be directly performed by a hardware processor, or may be performed by using a combination of hardware in the processor and a software module. The software module may be located in a mature storage medium in the art, such as a random access memory, a flash memory, a read-only memory, a programmable read-only memory, an electrically erasable programmable memory, or a register. The storage medium is located in the memory 820, and the processor 810 reads information in the memory 820 and completes the operations in the foregoing methods in combination with hardware of the processor 810. To avoid repetition, details are not described herein again.

It should be understood that, in embodiments of this application, the processor may be one or more integrated circuits, and is configured to execute a related program, to perform the method embodiments of this application.

The processor (for example, the processor 810) may include one or more processors and is implemented as a combination of computing devices. The processor may include one or more of the following: a microprocessor, a microcontroller, a digital signal processor (DSP), a digital signal processing device (DSPD), an application-specific integrated circuit (ASIC), a field programmable gate array (FPGA), a programmable logic device (PLD), gate logic, transistor logic, a discrete hardware circuit, a processing circuit, other appropriate hardware or firmware, and/or another appropriate combination of hardware and software, and is configured to perform various functions described in the present disclosure. The processor may be a general-purpose processor or a special-purpose processor. For example, the processor 810 may be a baseband processor or a central processing unit. The baseband processor may be configured to process a communication protocol and communication data. The central processing unit may be configured to enable the apparatus to execute a software program and process data in the software program. A part of the processor may further include a non-volatile random access memory. For example, the processor may further store information of a device type.

The program in this application represents software in a broad sense. A non-limitative example of the software includes program code, a program, a subprogram, instructions, an instruction set, code, a code segment, a software module, an application program, a software application program, or the like. The program may be run in a processor and/or a computer. In this way, the apparatus can perform various functions and/or processes described in this application.

The memory (for example, the memory 820) may store data required by the processor (for example, the processor 810) during software execution. The memory may be implemented by using any suitable storage technology. For example, the memory may be any available storage medium that can be accessed by the processor and/or the computer. A non-limitative example of the storage medium includes: a random access memory (RAM), a read-only memory (ROM), an electrically erasable programmable read-only memory (electrically EPROM, EEPROM), a compact disc read-only memory (Compact Disc-ROM, CD-ROM), a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), a direct rambus random access memory (direct rambus RAM, DR RAM), a removable medium, an optical disc memory, a magnetic disk storage medium, a magnetic storage device, a flash memory, a register, a status memory, a remote mounted memory, a local or remote memory component, or any other medium capable of carrying or storing software, data, or information and accessible by the processor/computer. It should be noted that the memory described in this specification aims to include but is not limited to these memories and any memory of another appropriate type.

The memory (for example, the memory 820) and the processor (for example, the processor 810) may be separately disposed or integrated together. The memory may be configured to connect to the processor, so that the processor can read information from the memory, and store information in and/or write information into the memory. The memory may be integrated into the processor. The memory and the processor may be disposed in an integrated circuit (for example, the integrated circuit may be disposed in UE or another network node).

FIG. 12 is a block diagram of a chip system 900 according to an embodiment of this application. The chip system 900 (or may be referred to as a processing system) includes a logic circuit 910 and an input/output interface (input/output interface) 920.

The logic circuit 910 may be a processing circuit in the chip system 900. The logic circuit 910 may be coupled to a storage unit, and invoke instructions in the storage unit, so that the chip system 900 can implement the methods and functions in embodiments of this application.

The input/output interface 920 may be an input/output circuit in the chip system 900, and outputs information processed by the chip system 900, or inputs to-be-processed data or signaling information to the chip system 900 for processing.

In a solution, the chip system 900 is configured to implement operations performed by the terminal device in the foregoing method embodiments.

For example, the logic circuit 910 is configured to implement a processing-related operation performed by the terminal device in the foregoing method embodiments, for example, a processing-related operation performed by the terminal device in the embodiment shown in FIG. 6. The input/output interface 920 is configured to implement a sending and/or receiving-related operation performed by the terminal device in the foregoing method embodiments, for example, a sending and/or receiving-related operation performed by the terminal device in the embodiment shown in FIG. 6.

In another solution, the chip system 900 is configured to implement operations performed by the network device in the foregoing method embodiments.

For example, the logic circuit 910 is configured to implement a processing-related operation performed by the network device in the foregoing method embodiments, for example, a processing-related operation performed by the network device in the embodiment shown in FIG. 6. The input/output interface 920 is configured to implement a sending and/or receiving-related operation performed by the terminal device in the foregoing method embodiments, for example, a sending and/or receiving-related operation performed by the network device in the embodiment shown in FIG. 6.

In another solution, the chip system 900 is configured to implement operations performed by the positioning server in the foregoing method embodiments.

For example, the logic circuit 910 is configured to implement a processing-related operation performed by the positioning server in the foregoing method embodiments, for example, a processing-related operation performed by the positioning server in the embodiment shown in FIG. 6. The input/output interface 920 is configured to implement a sending and/or receiving-related operation performed by the positioning server in the foregoing method embodiments, for example, a sending and/or receiving-related operation performed by the positioning server in the embodiment shown in FIG. 6.

An embodiment of this application further provides a computer-readable storage medium, where the computer-readable storage medium stores computer instructions for implementing the method performed by the communication apparatus (such as the terminal device, the network device, or the positioning server) in the foregoing method embodiments

An embodiment of this application further provides a computer program product, including instructions. When the instructions are executed by a computer, the method performed by the communication apparatus (such as the terminal device, the network device, or the positioning server) in the foregoing method embodiments is implemented.

An embodiment of this application further provides a communication system. The communication system includes one or more of the terminal device, the network device, or the positioning server in the foregoing embodiments.

For explanations and beneficial effect of related content in any one of the apparatuses provided above, refer to the corresponding method embodiment provided above. Details are not described herein again.

In the several embodiments provided in this application, it should be understood that the disclosed apparatus and method may be implemented in other manners. For example, the foregoing apparatus embodiments are only examples. For example, division into the foregoing units is only logical function division, and may be another division manner in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The foregoing units described as separate parts may or may not be physically separate, and parts displayed as units may or may not be physical units, may be located in one position, or may be distributed on a plurality of network units. Some or all of the units may be selected based on actual requirements to implement the solutions provided in this application.

In addition, functional units in embodiments of this application may be integrated into one unit, each of the units may exist alone physically, or two or more units may be integrated into one unit.

A person of ordinary skill in the art may be aware that, in combination with the examples described in embodiments disclosed in this specification, units and algorithm operations may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the scope of this disclosure may cover material that is beyond the described embodiments.

When software is used to implement the embodiments, all or a part of the embodiments may be implemented in a form of a computer program product. The computer program product includes one or more computer instructions. When the computer program instructions are loaded and executed on the computer, the procedure or functions according to embodiments of this application are all or partially generated. The computer may be a general-purpose computer, a dedicated computer, a computer network, or other programmable apparatuses. For example, the computer may be a personal computer, a server, or a network device. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. For the computer-readable storage medium, refer to the foregoing descriptions.

The foregoing descriptions are describe various embodiments of this application, but are not intended to limit the scope of this application. Any variation or replacement readily figured out by a person skilled in the art within the scope disclosed in this application shall fall within the protection of this disclosure. The protective scope of this disclosure shall be subject to the scope of the claims.

1. A communication method, comprising:
receiving a first downlink frame from a second communication apparatus;
sending a first uplink frame to the second communication apparatus; and
sending first information to a positioning server, wherein the first information indicates a first time difference between a receiving time for receiving an i^{th} first downlink subframe in the first downlink frame and a sending time for sending a k^{th} first uplink subframe in the first uplink frame.

2. The method according to claim 1, wherein
the first information comprises the first time difference, and the first time difference comprises a sum of a third time difference and a fourth time difference; or
the first information the third time difference and the fourth time difference; and
wherein the third time difference is a time difference between the receiving time for the i^{th} first downlink subframe and a sending time for sending a second uplink subframe, the sending time for the second uplink subframe is closest to the receiving time for the i^{th} first downlink subframe, and the fourth time difference is a time difference between the sending time for the second uplink subframe and the sending time for the k^{th} first uplink subframe.

3. The method according to claim 2, wherein the method further comprises:
sending first indication information to the second communication apparatus, wherein the first indication information indicates a subframe number of the second uplink subframe; or
the second uplink subframe carries a reference signal.

4. The method according to claim 1, wherein
the first information comprises the first time difference, and the first time difference is a time difference between a first moment and a second moment; or
the first information comprises the first moment and the second moment;
wherein the first moment occurs when receiving the i^{th} first downlink subframe, and the second moment occurs when sending the k^{th} first uplink subframe.

5. The method according to claim 1, wherein the method further comprises:
sending a second uplink frame to the second communication apparatus; and
receiving a second downlink frame from the second communication apparatus, wherein
the second uplink frame is used to determine second information, and the second information indicates a second time difference between a receiving time for receiving an x^{th} third uplink subframe in the second uplink frame and a sending time for sending a y^{th} third downlink subframe in the second downlink frame.

6. The method according to claim 5, wherein
the second information comprises the second time difference, and the second time difference comprises a sum of an eighth time difference and a ninth time difference; or
the second information comprises the eighth time difference and the ninth time difference;
wherein the eighth time difference is a time difference between the receiving time for the x^{th} third uplink subframe and sending time for sending a fourth downlink subframe, the sending time for the fourth downlink subframe is closest to the receiving time for the x^{th} third uplink subframe, and the ninth time difference is a time difference between the sending time for the fourth downlink subframe and the sending time for the y^{th} third downlink subframe.

7. The method according to claim 5, wherein
the second information comprises the second time difference, and the second time difference is a time difference between a third moment and a fourth moment; or
the first information comprises the third moment and the fourth moment;
wherein the third moment occurs when receiving the x^{th} third uplink subframe, and the fourth moment occurs when sending the y^{th} third downlink subframe.

8. A communication method, comprising:
sending a first downlink frame to a first communication apparatus;
receiving a first uplink frame from the first communication apparatus;
receiving first information from the first communication apparatus, wherein the first information indicates a first time difference between a receiving time for receiving an i^{th} first downlink subframe in the first downlink frame and a sending time for sending a k^{th} first uplink subframe in the first uplink frame; and
sending the first information to a positioning server, wherein the first information is used by the positioning server to verify a location of a terminal device.

9. The method according to claim 8, wherein
the first information comprises the first time difference, and the first time difference comprises a sum of a third time difference and a fourth time difference; or
the first information comprises the third time difference and the fourth time difference; and
the third time difference is a time difference between the receiving time for the i^{th} first downlink subframe and sending time for sending a second uplink subframe, the sending time for the second uplink subframe is closest to the receiving time for the i^{th} first downlink subframe, and the fourth time difference is a time difference between the sending time for the second uplink subframe and the sending time for the k^{th} first uplink subframe.

10. The method according to claim 9, wherein the method further comprises:
receiving first indication information from the first communication apparatus, wherein the first indication information indicates a subframe number of the second uplink subframe; or
the second uplink subframe carries a reference signal.

11. The method according to claim 8, wherein
the first information comprises the first time difference, and the first time difference is a time difference between a first moment and a second moment; or
the first information comprises the first moment and the second moment;
wherein the first moment occurs when receiving the i^{th} first downlink subframe, and the second moment occurs when sending the k^{th} first uplink subframe.

12. The method according to claim 8, wherein the method further comprises:
receiving a second uplink frame from the first communication apparatus;
sending a second downlink frame to the first communication apparatus; and
sending second information to the positioning server, wherein the second information indicates a second time difference between a receiving time for receiving an x^{th} third uplink subframe in the second uplink frame and a sending time for sending a y^{th} third downlink subframe in the second downlink frame.

13. The method according to claim 12, wherein
the second information comprises the second time difference, and the second time difference comprises a sum of an eighth time difference and a ninth time difference; or
the second information comprises the eighth time difference and the ninth time difference;
wherein the eighth time difference is a time difference between the receiving time for the x^{th} third uplink subframe and sending time for sending a fourth downlink subframe, the sending time for the fourth downlink subframe is closest to the receiving time for the x^{th} third uplink subframe, and the ninth time difference is a time difference between the sending time for the fourth downlink subframe and the sending time for the y^{th} third downlink subframe.

14. The method according to claim 12, wherein
the second information comprises the second time difference, and the second time difference is a time difference between a third moment and a fourth moment; or
the first information comprises the third moment and the fourth moment;
wherein the third moment occurs when receiving the x^{th} third uplink subframe, and the fourth moment occurs when sending the y^{th} third downlink subframe.

15. An apparatus, comprising:
at least one processor; and
one or more memories coupled to the at least one processor and storing program instructions for execution by the at least one processor to cause the apparatus to:
receive a first downlink frame from a second communication apparatus;
send a first uplink frame to the second communication apparatus; and
send first information to a positioning server, wherein the first information indicates a first time difference between a receiving time for receiving an i^{th} first downlink subframe in the first downlink frame and a sending time for sending a k^{th} first uplink subframe in the first uplink frame.

16. The apparatus according to claim 15, wherein
the first information comprises the first time difference, and the first time difference comprises a sum of a third time difference and a fourth time difference; or
the first information comprises the third time difference and the fourth time difference;
wherein the third time difference is a time difference between the receiving time for the i^{th} first downlink subframe and sending time for sending a second uplink subframe, the sending time for the second uplink subframe is closest to the receiving time for the i^{th} first downlink subframe, and the fourth time difference is a time difference between the sending time for the second uplink subframe and the sending time for the k^{th} first uplink subframe.

17. The apparatus according to claim 16, wherein the apparatus is further to:
send first indication information to the second communication apparatus, wherein the first indication information indicates a subframe number of the second uplink subframe; or
the second uplink subframe carries a reference signal.

18. The apparatus according to claim 15, wherein
the first information comprises the first time difference, and the first time difference is a time difference between a first moment and a second moment; or
the first information comprises the first moment and the second moment;
wherein the first moment occurs when receiving the i^{th} first downlink subframe, and the second moment occurs when sending the k^{th} first uplink subframe.

19. The apparatus according to claim 15, wherein the apparatus is further to:
send a second uplink frame to the second communication apparatus; and
receive a second downlink frame from the second communication apparatus, wherein
the second uplink frame is used to determine second information, and the second information indicates a second time difference between a receiving time for receiving an x^{th} third uplink subframe in the second uplink frame and a sending time for sending a y^{th} third downlink subframe in the second downlink frame.

20. The apparatus according to claim 19, wherein
the second information comprises the second time difference, and the second time difference comprises a sum of an eighth time difference and a ninth time difference; or
the second information comprises the eighth time difference and the ninth time difference;
wherein the eighth time difference is a time difference between the receiving time for the x^{th} third uplink subframe and sending time for sending a fourth downlink subframe, the sending time for the fourth downlink subframe is closest to the receiving time for the x^{th} third uplink subframe, and the ninth time difference is a time difference between the sending time for the fourth downlink subframe and the sending time for the y^{th} third downlink subframe.
